(19) United States
(12) Patent Application Publication
(10) Pub. No.: US 2007/0184831 A1
(43) Pub. Date: Aug. 9, 2007

(54) Communication system

(76) Inventor: Shinichi Morimoto, Tokyo (JP)

Correspondence Address: YOUNG & THOMPSON, 745 SOUTH 23RD STREET, 2ND FLOOR, ARLINGTON, VA, 22202, US

(21) Appl. No.: 10/562,918

(22) PCT Filed: Jun. 29, 2004
(86) PCT No.: PCT/JP04/09144

§ 371 Date: Jul. 19, 2006

(30) Foreign Application Priority Data
Jun. 30, 2003 (JP) 2003-188870

(51) Int. Cl. H04Q 7/20

(52) U.S. Cl. 455/432.1

(57) ABSTRACT

A communication system for allowing communication efficiency to be improved for at least a part of stations in a LAN wherein the plurality of stations are installed in a movable body. A communication system comprising a plurality of access points (1,2,3 . . . ) located along a predetermined path; stations (31,32) installed in a movable body (100) that moves along the predetermined path; and a network (61) provided in the movable body for connecting the stations (31,32); wherein the station (31) or station (32) that has become associated with any one of the access points (1,2,3 . . . ) via radio communication is connected to a network (81) via that access point, and wherein the front station (31) in the traveling direction of the movable body (100) obtains information, when searching for an access point with which the front station (31) can become associated, and informs the obtained information to the station (32) via the network (61) in the movable body.

### BACKGROUND OF THE INVENTION

1. Field of the Invention

This invention relates to a communication system for causing a station arranged on a mobile body is required to belong to one of a plurality of access points arranged along a predetermined route so as to connect itself to a network. More particularly, the present invention relates to a communication system that can reduce the time required for a station to switch access points.

2. Description of the Related Art

In a LAN utilizing wireless communications (wireless LAN), each subscriber station (station) is required to belong to one of a plurality of base stations, which is referred to as access points, so as to connect itself to the network.

Generally, the access points of a wireless LAN have respective identifiers that are different from each other and each of them communicates with the stations belonging to it by way of a channel (frequency) that is different from the channels (frequencies) of the remaining access points. Therefore, a station that wants to belong to an access point has to acquire the channel and the identifier of the access point.

Thus, a station that wants to belong to an access point performs a scanning operation for detecting the beacon that the access point transmits periodically and acquires the channel and the identifier to be used for the purpose of communicating with the access point according to the detected beacon.

To cope with the current situation where the number of services provided by networks has been and being ever increasing, there has been a strong demand for improved communication infrastructures that allow mobile bodies (vehicles) such as trains and automobiles to be connected to networks.

To meet the demand, Patent Document 1 (Jpn. Pat. Appln. Laid-Open Publication No. 2002-344478) proposes a technique of arranging a large number of access points along railroads and automobile roads and causing stations arranged on mobile bodies to belong to one of the access points in order to allow the station on the running mobile body to access a network.

When a mobile body mounted by a plurality of stations is moving and the stations mounted in the running mobile body are connected to a network by means of the known technique described above, the stations are required to sequentially switch the access points they belong to as the mobile body moves.

However, with the known technique, if the cells of the access points are small relative to the moving speed of the mobile body, each station has to perform a scanning operation and switch access points it belongs to very frequently.

The time period during which a station is performing a scanning operation is a time period when the station is located within the service area of the cell but cannot establish communication with the access point. Therefore, the efficiency of communication falls if the station is required to switch access points frequently.

With the above-described known technique, the time period that a station is required to spend for a scanning operation is related neither to the moving speed of the mobile body where the station is arranged nor to the cell size. On the other hand, the time period that a station spends from the time when it enters the cell of an access point to the time when it leaves the cell varies as a function of the moving speed of the mobile body and the cell size.

Therefore, the time period that has to be spent for a scanning operation takes a large ratio relative to the time period during which the station can transmit/receive information when the moving speed of the mobile body is raised and/or when the above-described technique is applied to an access point of a small cell size.

For example, in the case of a wireless LAN that conforms to the IEEE802/11 Standard, fourteen channels are used for wireless communications and an access point generally transmits a beacon at every 100 to 300 ms. A station is required to perform a scanning operation for each channel.

Thus, when a station tries to perform a scanning operation sequentially, starting from the first channel, it waits and sees if a beacon is being transmitted for the first channel for a predetermined period of time and, if no beacon is being transmitted, it then waits and sees if a beacon is being transmitted for the second channel. In this way, the station repeats the same operation. Therefore, for a station that utilizes the above-described known technique, it takes maximally 300 ms×14=4.2 seconds from the time it starts a scanning operation to the time when it acquires information on an access point.

Then, if a station remains in the service area of an access point for 20 seconds from the time when it enters the cell to the time when it leaves the cell, the station can transmit/receive information at least for 16 seconds or less out of the 20 seconds. If, however, a station remains in the service area of an access point for 5 seconds from the time it enters the cell to the time when it leaves the cell, the time period available to the station for transmitting/receiving information is less than 1 second in the shortest case.

If the time period during which a station remains in the service area of an access point from the time it enters the cell to the time when it leaves the cell is less than the time period that has to be spent for a scanning operation, it is no longer possible for the station to make itself belong to the access point.

With the known base station switching method, each station is required to perform a scanning operation individually. Therefore, the efficiency of communication can be low because the time period that needs to be spent by a station for a scanning operation provides a bottle neck.

### SUMMARY OF THE INVENTION

In view of the above-identified problem, it is therefore an object of the present invention to provide a communication system that can improve the efficiency of communication in a LAN having a plurality of stations mounted in a mobile body for at least part of the stations.

In the first aspect of the present invention, the above object is achieved by providing any of the communication systems defined in 1-1 through 1-8 below.

1-1: A communication system comprising: a plurality of access point apparatus arranged along a predetermined route, a plurality of station apparatus arranged on a mobile body adapted to move along the predetermined route and an intra-mobile-body communication network for connecting the plurality of station apparatus, the station apparatus being adapted to become belonging to one of the access point apparatus by wireless communication so as to be connected to a network by way of the access point apparatus, the station apparatus located front-most in the moving direction of the mobile body being adapted to notify the other station apparatus with the information acquired at the time of retrieving an access point apparatus to be belonging to by way of the intra-mobile-body communication network.

1-2: A communication system comprising: a plurality of access point apparatus arranged along a predetermined route, a plurality of station apparatus arranged on a mobile body adapted to move along the predetermined route and an intra-mobile-body communication network for connecting the plurality of station apparatus, the station apparatus being adapted to become belonging to one of the access point apparatus by wireless communication so as to be connected to a network by way of the access point apparatus, each of the station apparatus having a means for judging if it is located front-most in the moving direction of the mobile body or not, the station apparatus judging itself to be located front-most in the moving direction of the mobile body being adapted to notify the other station apparatus with the information acquired at the time of retrieving an access point apparatus to be belonging to by way of the intra-mobile-body communication network.

1-3: A communication system comprising: a plurality of access point apparatus arranged along a predetermined route, a plurality of station apparatus arranged on a mobile body adapted to move along the predetermined route and an intra-mobile-body communication network for connecting the plurality of station apparatus, the station apparatus being adapted to become belonging to one of the access point apparatus by wireless communication so as to be connected to a network by way of the access point apparatus, the station apparatus other than the station apparatus located front-most in the moving direction of the mobile body being adapted to acquire the information acquired by the station apparatus located front-most in the moving direction of the mobile body at the time of retrieving an access point apparatus to be belonging to by way of the intra-mobile-body communication network.

1-4: A communication system comprising: a plurality of access point apparatus arranged along a predetermined route, a plurality of station apparatus arranged on a mobile body adapted to move along the predetermined route and an intra-mobile-body communication network for connecting the plurality of station apparatus, the station apparatus being adapted to become belonging to one of the access point apparatus so as to be connected to a network by way of the access point apparatus, each of the station apparatus having a means for judging if it is located front-most in the moving direction of the mobile body or not, the station apparatus other than the station apparatus located front-most in the moving direction of the mobile body being adapted to acquire the information acquired by the station apparatus located front-most in the moving direction of the mobile body at the time of retrieving an access point apparatus to be belonging to by way of the intra-mobile-body communication network.

1-5: A communication system comprising: a plurality of access point apparatus arranged along a predetermined route, a plurality of station apparatus arranged on a mobile body adapted to move along the predetermined route and an intra-mobile-body communication network for connecting the plurality of station apparatus, the station apparatus being adapted to become belonging to one of the access point apparatus so as to be connected to a network by way of the access point apparatus, the system further comprising a storage means connected to the intra-mobile-body communication network and adapted to store information showing the access point apparatus to which each of the station apparatus used to belong to, the station apparatus located front-most in the moving direction of the mobile body being adapted to store the information it acquires at the time of retrieving an access point apparatus to be belonging to in the storage means by way of the intra-mobile-body communication network, the station apparatus other than the station apparatus located front-most in the moving direction of the mobile body being adapted to refer to the information stored in the storage means by the front-most station apparatus prior to retrieving an access point apparatus to be belonging to.

1-6: A communication system comprising: a plurality of access point apparatus arranged along a predetermined route, a plurality of station apparatus arranged on a mobile body adapted to move along the predetermined route and an intra-mobile-body communication network for connecting the plurality of station apparatus, the station apparatus being adapted to become belonging to one of the access point apparatus so as to be connected to a network by way of the access point apparatus, each of the station apparatus having a storage means for storing information showing the access point apparatus to which it used to belong to, the station apparatus located front-most in the moving direction of the mobile body being adapted to store the information it acquires at the time of retrieving an access point apparatus to be belonging to in its storage means, the station apparatus other than the station apparatus located front-most in the moving direction of the mobile body being adapted to refer to the information stored by the front-most station apparatus in its storage means prior to retrieving an access point apparatus to be belonging to.

1-7: A communication system comprising: a plurality of access point apparatus arranged along a predetermined route, a plurality of station apparatus arranged on a mobile body adapted to move along the predetermined route, and an intra-mobile-body communication network for connecting the plurality of station apparatus, the station apparatus being adapted to become belonging to one of the access point apparatus so as to be connected to a network by way of the access point apparatus, the system further comprising a storage means connected to the intra-mobile-body communication network and adapted to store information showing the access point apparatus to which each of the station apparatus used to belong to, each of the station apparatus having a means for judging if it is located front-most in the moving direction of the mobile body or not, the station apparatus located front-most in the moving direction of the mobile body being adapted to store the information it acquires at the time of retrieving an access point apparatus to be belonging to in the storage means by way of the intra-mobile-body communication network, the station apparatus other than the station apparatus located front-most in the moving direction of the mobile body being adapted to refer to the information stored in the storage means by the front-most station apparatus prior to retrieving an access point apparatus to be belonging to.

1-8: A communication system comprising: a plurality of access point apparatus arranged along a predetermined route, a plurality of station apparatus arranged on a mobile body adapted to move along the predetermined route, and an intra-mobile-body communication network for connecting the plurality of station apparatus, the station apparatus being adapted to become belonging to one of the access point apparatus so as to be connected to a network by way of the access point apparatus, each of the station apparatus having a means for judging if it is located front-most in the moving direction of the mobile body or not and a storage means for storing information showing the access point apparatus to which it used to belong to, the station apparatus located front-most in the moving direction of the mobile body being adapted to store the information it acquires at the time of retrieving an access point apparatus to be belonging to in its storage means, the station apparatus other than the station apparatus located front-most in the moving direction of the mobile body being adapted to refer to the information stored by the front-most station apparatus in its storage means prior to retrieving an access point apparatus to be belonging to.

With the above-described arrangement of 1-7 or 1-8 in the first aspect of the present invention, preferably each of the station apparatus judges if it is located front-most in the moving direction of the mobile body or not according to the information stored in the storage means by itself and by the other station apparatus.

With any of the above-described arrangements in the first aspect of the present invention, when two or more than two station apparatus are located front-most in the moving direction of the mobile body, at least one of the station apparatus keeps on belonging to the access point apparatus it has been belonging to if the communication quality is degraded relative to the access point apparatus, while the remaining station apparatus retrieves or retrieve the access point apparatus to be belonging to.

In the second aspect of the present invention, the above object is achieved by providing any of the communication systems defined in 2-1 through 2-4 below.

2-1: A communication system comprising: a plurality of access point apparatus arranged along a predetermined route, a plurality of station apparatus arranged on a plurality of mobile bodies adapted to move in the same direction along the predetermined route, each of the mobile bodies having at least a station apparatus arranged thereon, and an intra-mobile-body communication network for connecting the plurality of station apparatus, the station apparatus being adapted to become belonging to one of the access point apparatus by wireless communication so as to be connected to a network by way of the access point apparatus, each of the station apparatus having a means for judging if the mobile body where it is arranged is located front-most in the moving direction of the mobile body or not, the station apparatus arranged on the mobile body located front-most in the moving direction being adapted to notify the other station apparatus with the information acquired at the time of retrieving an access point apparatus to be belonging to by way of an intra-mobile-body communication network.

2-2: A communication system comprising: a plurality of access point apparatus arranged along a predetermined route, a plurality of station apparatus arranged on a plurality of mobile bodies adapted to move in the same direction along the predetermined route, each of the mobile bodies having at least a station apparatus arranged thereon, and an intra-mobile-body communication network for connecting the plurality of station apparatus, the station apparatus being adapted to become belonging to one of the access point apparatus by wireless communication so as to be connected to a network by way of the access point apparatus, each of the station apparatus having a means for judging if the mobile body where it is arranged is located front-most in the moving direction of the mobile body or not, the station apparatus arranged on the moving bodies not located front-most in the moving direction being adapted to acquire the information acquired by the station apparatus arranged on the mobile body located front-most in the moving direction at the time of retrieving an access point apparatus to be belonging to by way of an intra-mobile-body communication network.

2-3: A communication system comprising: a plurality of access point apparatus arranged along a predetermined route, a plurality of station apparatus arranged on a plurality of mobile bodies adapted to move in the same direction along the predetermined route, each of the mobile bodies having at least a station apparatus arranged thereon, and an inter-mobile-body communication network for connecting the plurality of station apparatus, the station apparatus being adapted to become belonging to one of the access point apparatus by wireless communication so as to be connected to a network by way of the access point apparatus, the system further comprising a storage means connected to the inter-mobile-body communication network and adapted to store the information showing the access point apparatus to which each of the station apparatus used to belong to, each of the station apparatus having a means for judging if the mobile body where it is arranged is located front-most in the moving direction of the mobile body or not, the station apparatus arranged on the mobile body located front-most in the moving direction being adapted to store the information it or they acquired at the time of retrieving an access point apparatus to be belonging to by way of an intra-mobile-body communication network, the station apparatus arranged on the moving bodies not located front-most in the moving direction being adapted to refer to the information stored in the storage means by the front-most station apparatus arranged on the mobile body located front-most in the moving direction prior to retrieving an access point apparatus to be belonging to.

2-4: A communication system comprising: a plurality of access point apparatus arranged along a predetermined route, a plurality of station apparatus arranged on a plurality of mobile bodies adapted to move in the same direction along the predetermined route, each of the mobile bodies having at least a station apparatus arranged thereon and an inter-mobile-body communication network for connecting the plurality of station apparatus, the station apparatus being adapted to become belonging to one of the access point apparatus so as to be connected to a network by way of the access point apparatus, each of the station apparatus having a means for judging if the mobile body where it is arranged is located front-most in the moving direction of the mobile body or not and a storage means for storing information showing the access point apparatus to which it used to belong to, the station apparatus arranged on the mobile body located front-most in the moving direction being adapted to store the information it or they acquired at the time of retrieving an access point apparatus to be belonging to in it or their storage means, whichever appropriate, the station apparatus arranged on the moving bodies not located front-most in the moving direction being adapted to refer to the information stored by the station apparatus arranged on the mobile body located front-most in the moving direction in its or their storage means prior to retrieving an access point apparatus to be belonging to.

With the above-described arrangement of 2-3 or 2-4 in the second aspect of the present invention, preferably each of the station apparatus judges if it is located front-most in the moving direction of the mobile body or not according to the information stored in the storage means by itself and by the other station apparatus.

With any of the above-described arrangements in the second aspect of the present invention, when two or more than two station apparatus are arranged on the mobile body located front-most in the moving direction, at least one of the station apparatus keeps on belonging to the access point apparatus it has been belonging to when the communication quality is degraded relative to the access point apparatus, while the remaining station apparatus retrieves or retrieve the access point apparatus to be belonging to.

Thus, according to the present invention, it is possible to provide a communication system that can improve the efficiency of communication in a LAN having a plurality of stations mounted on one or more than one vehicles of a transportation system for at least part of the stations.

### BRIEF DESCRIPTION OF THE DRAWINGS

FIG. 1 is a schematic block diagram of the first embodiment of communication system according to the invention that suitably embodies the present invention, showing the configuration thereof;

FIG. 2 is a schematic block diagram of a station of the communication system of the first embodiment, showing the configuration thereof;

FIG. 3 is a flowchart of the operation of the station that is arranged at the front side of a mobile body;

FIG. 4 is a flowchart of the operation of the station that is arranged at the rear side of a mobile body;

FIG. 5A is a schematic illustration of a mobile body moving on a predetermined route;

FIG. 5B is a chart illustrating how the belonging situations of stations change as a mobile body having a communication system according to the invention moves;

FIG. 5C is a chart illustrating how the belonging situations of stations change as a mobile body having a known communication system moves;

FIG. 6 is a flowchart of the operation of the station arranged at the front end of a mobile body as viewed in the moving direction of the mobile body;

FIG. 7 is a flowchart of the operation of the station arranged at the rear end of a mobile body as viewed in the moving direction of the mobile body;

FIG. 8A is a schematic illustration of a mobile body moving on a predetermined route;

FIG. 8B is a chart illustrating how the belonging situation changes when the station mounted at the front end of a mobile body as viewed in the moving direction notifies the station mounted at the rear end of the mobile body of the progress of the ongoing Scanning operation;

FIG. 9 is a chart illustrating how the station mounted at the front end of a mobile body notifies the station mounted at the rear end of the mobile body of the progress of the ongoing Scanning operation;

FIG. 10 is a schematic illustration of a mobile body passing through the cells of access points having communication directivity;

FIG. 11A is a chart illustrating how the belonging situations of stations of a communication system according to the invention change when the mobile body is passing through the cells of access points having directivity;

FIG. 11B is a chart illustrating how the belonging situations of stations of a known communication system change when the mobile body is passing through the cells of access points having directivity;

FIG. 12 is a schematic block diagram of a station of a second embodiment of communication system according to the invention that suitably embodies the present invention, showing the configuration thereof;

FIG. 13A is a chart of the information that may be stored in a belonging history information storage section of the second embodiment, illustrating belonging history information;

FIG. 13B is a chart of the information that may be stored in the belonging history information storage section, illustrating AP information;

FIG. 14 is a flowchart of the operation of a station of the second embodiment of communication system according to the invention;

FIG. 15 is a flowchart of the processing operation of a station for judging if it is arranged at the front end or the mobile body on which it is mounted or not as viewed in the moving direction of the mobile body;

FIG. 16 is a schematic block diagram of a third embodiment of communication system according to the invention that suitably embodies the present invention, showing the configuration thereof;

FIG. 17 is a schematic block diagram of a station of the communication system of the third embodiment, showing the configuration thereof;

FIG. 18 is a schematic block diagram of a fourth embodiment of communication system according to the invention that suitably embodies the present invention, showing the configuration thereof;

FIG. 19 is a schematic illustration of a handing over operation of the communication system of the fourth embodiment;

FIG. 20 is a schematic block diagram of a fifth embodiment of communication system according to the invention that suitably embodies the present invention, showing the configuration thereof; and

FIG. 21 is a schematic block diagram of a station of the communication system of the fifth embodiment, showing the configuration thereof.

### DETAILED DESCRIPTION OF THE PREFERRED EMBODIMENTS

### First Embodiment

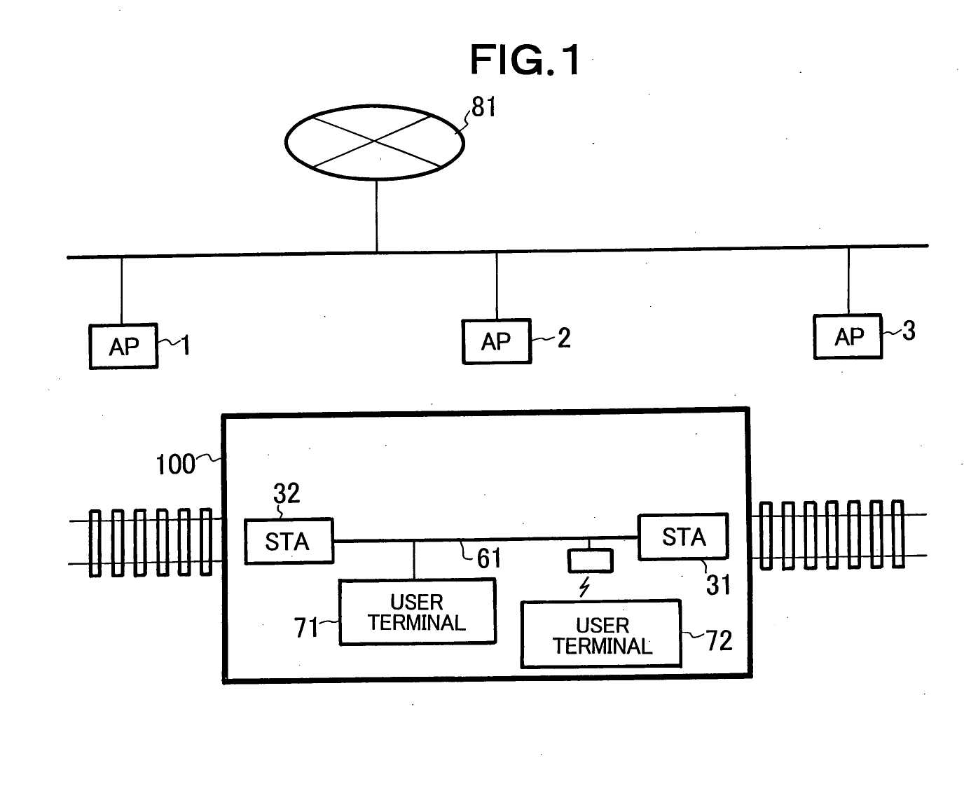

Now, the first embodiment of the present invention that suitably embodies the present invention will be described below. FIG. 1 schematically illustrates the first embodiment of communication system according to the invention.

The communication system of this embodiment comprises access points (AP) 1, 2, 3, . . . arranged along a railroad and stations (STA) 31 and 32 are arranged on a mobile body 100 (railway train) that moves on the railroad and connected to each other by way of an intra-mobile-body network 61.

In the communication system, user terminals 71, 72 come to be connected to a network 81 as the stations 31 and 32 come to belong to one of the access points 1, 2, 3.

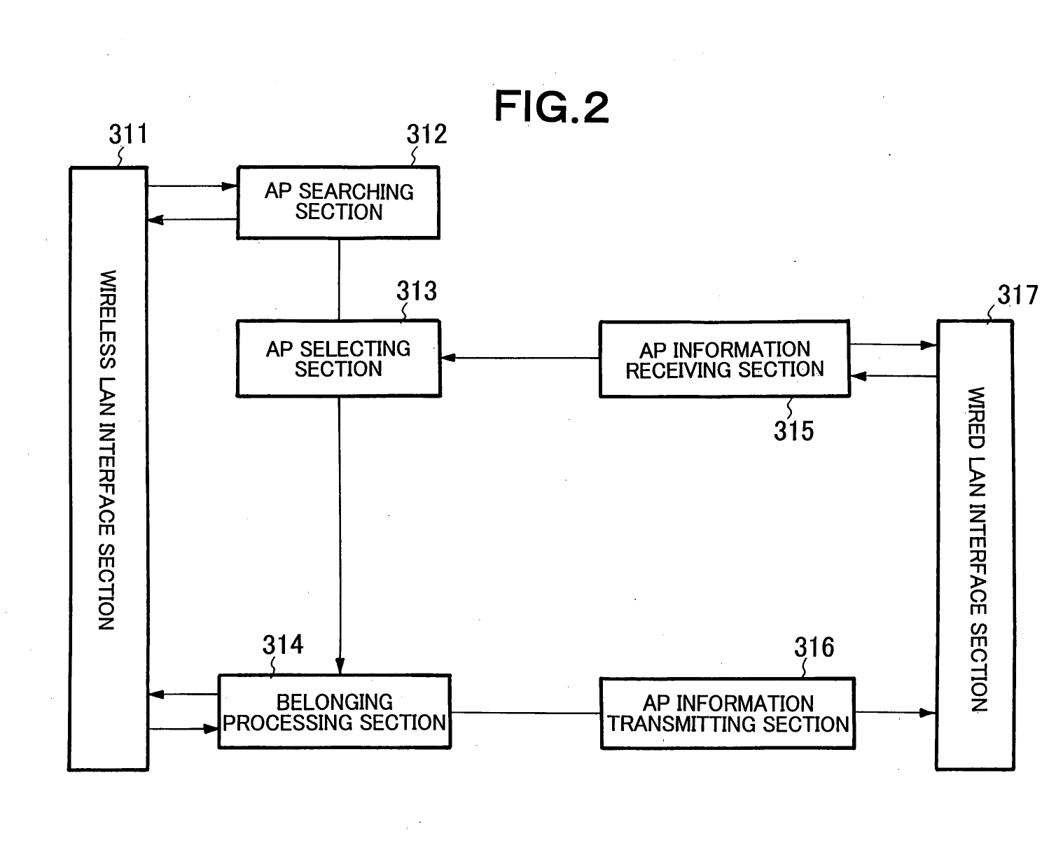

FIG. 2 is a schematic block diagram of each of the stations, showing the configuration thereof. The station 31 comprises a wireless LAN interface section 311, an AP searching section 312, an AP selecting section 313, a belonging processing section 314, an AP information receiving section 315, an AP information transmitting section 316 and an wired LAN interface section 317.

The wireless LAN interface section 311 is an interface for transmitting radio signals to and receiving radio signals from an access point. The AP searching section 312 performs a processing operation (or a Scanning operation) for detecting the beacon transmitted from an access point and acquires the channel and the identifier of the access point from the beacon it detects. The AP selecting section 313 selects the access point to which it is going to belong according to the outcome of the Scanning operation by the AP searching section 312. The belonging processing section 314 transmits a belonging request to the access point selected by the AP-selecting section 313 by means of the channel and the identifier acquired by the AP searching section 312. The AP information receiving section 315 receives information on the access point (the channel being used by the access point and the identifier thereof from the other station by way of an intra-mobile-body communication network 40. The AP information transmitting section 316 transmits information on the access point to the other station by way of the intra-mobile-body communication network 40. The wired LAN interface section 317 is an interface for transmitting/receiving information by way of the intra-mobile-body communication network 40. Since the station 32 has a configuration similar to that of the station 31, it will not be described any further.

In this embodiment, it is predefined that the STA 31 is arranged at the front side and the STA 32 is arranged at the rear side of the mobile body as viewed in the moving direction of the mobile body and the STAs know the positional arrangement. Now, the operation of each of the STAs will be described below.

### OPERATION EXAMPLE 1-1

Now, the first operation example of the communication system of this embodiment will be described below. Firstly, the individual operation of the STA 31 and that of the STA 32 will be discussed separately.

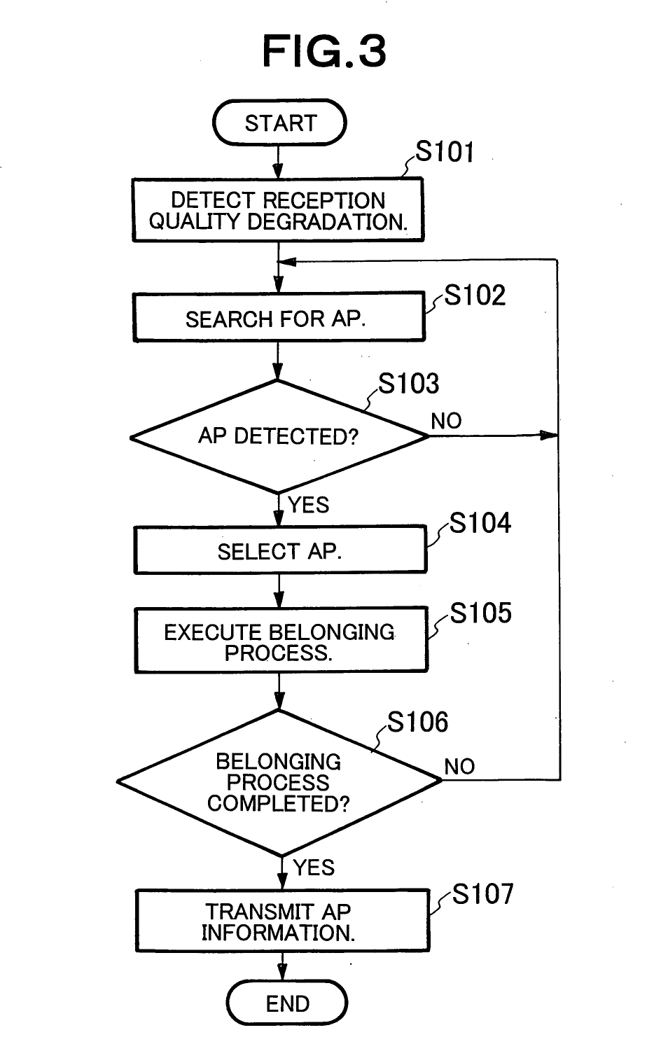

Firstly, the operation of the STA 31 that is arranged at the front side will be described. FIG. 3 is a flowchart of the operation of the STA 31.

If the STA 31 cannot wirelessly communicate with any access point with a predetermined quality of signal reception (including a situation where no communication is established with any access point) (Step S101), the AP searching section 312 performs a Scanning operation of detecting an access point to which it is to belong to, searching for the beacon transmitted from an access point (Step S102). If the STA 31 cannot detect a beacon by the Scanning operation (Step S103/No), the AP searching section 312 repeats the Scanning operation until it can detect a beacon.

As the AP searching section 312 detects a beacon by the Scanning operation (Step S103/Yes), the AP selecting section 313 acquires the frequency and the identifier of the beacon and selects the access point that is transmitting the beacon as an addressee to whom a belonging request is to be transmitted (Step S104). The belonging processing section 314 transmits a belonging request to the access point selected by the AP selecting section 313. The belonging request is transmitted by means of the frequency and the identifier of the beacon detected by the AP searching section 312 (Step S105).

The belonging process is completed when the access point that receives the belonging request authenticates the STA 31 (Step S106/Yes). If, on the other hand, the access point that receives the belonging request does not authenticate the STA 31 (Step S106/No), the AP searching section 312 performs a Scanning operation, searching for a beacon (Step S102).

When the belonging process to the access point is completed, the STA 31 notifies the rearward STA 32 of AP information (the channel being used by the access point and the identifier thereof and terminates the process.

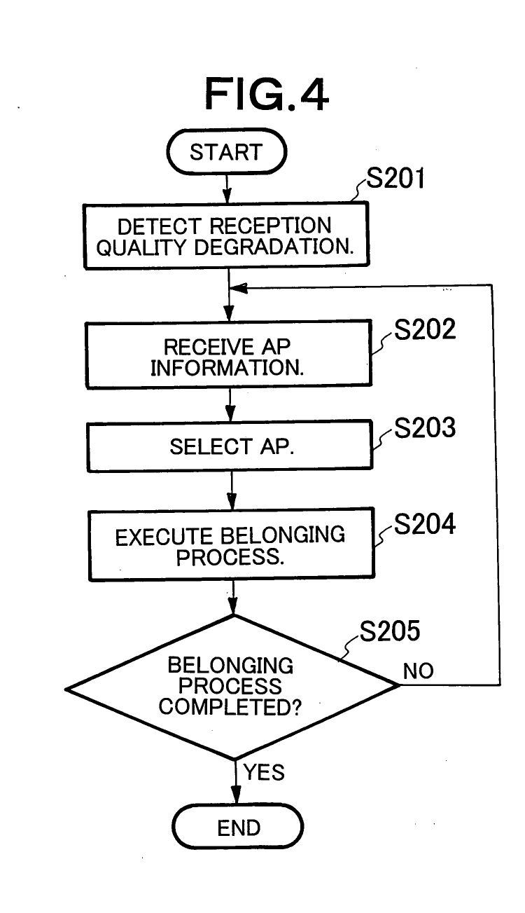

Now, the operation of the STA 32 that is arranged at the rear side will be described. FIG. 4 is a flowchart of the operation of the STA 32.

If the STA 32 cannot wirelessly communicate with any access point with a predetermined quality of signal reception (including a situation where no communication is established with any access point) (Step S201), the AP selecting section 323 selects an access point as the addressee to whom a belonging request is to be transmitted (Step S203) according to the most updated AP information it is notified of by the STA 31 (Step S202). A belonging processing section 324 transmits a belonging request to the access point selected by the AP selecting section 313. The belonging request is transmitted by means of the frequency and the identifier contained in the latest AP information it is notified of by the STA 31 (Step S204).

The belonging process is completed when the access point that receives the belonging request authenticates the STA 32 (Step S20/Yes). If, on the other hand, the access point that receives the belonging request does not authenticate the STA 32 (Step S205/No), the AP selecting section 323 selects an access point as the addressee to whom a belonging request is to be transmitted according to the most updated AP information it is notified of by the STA 31 (Steps S202, S203).

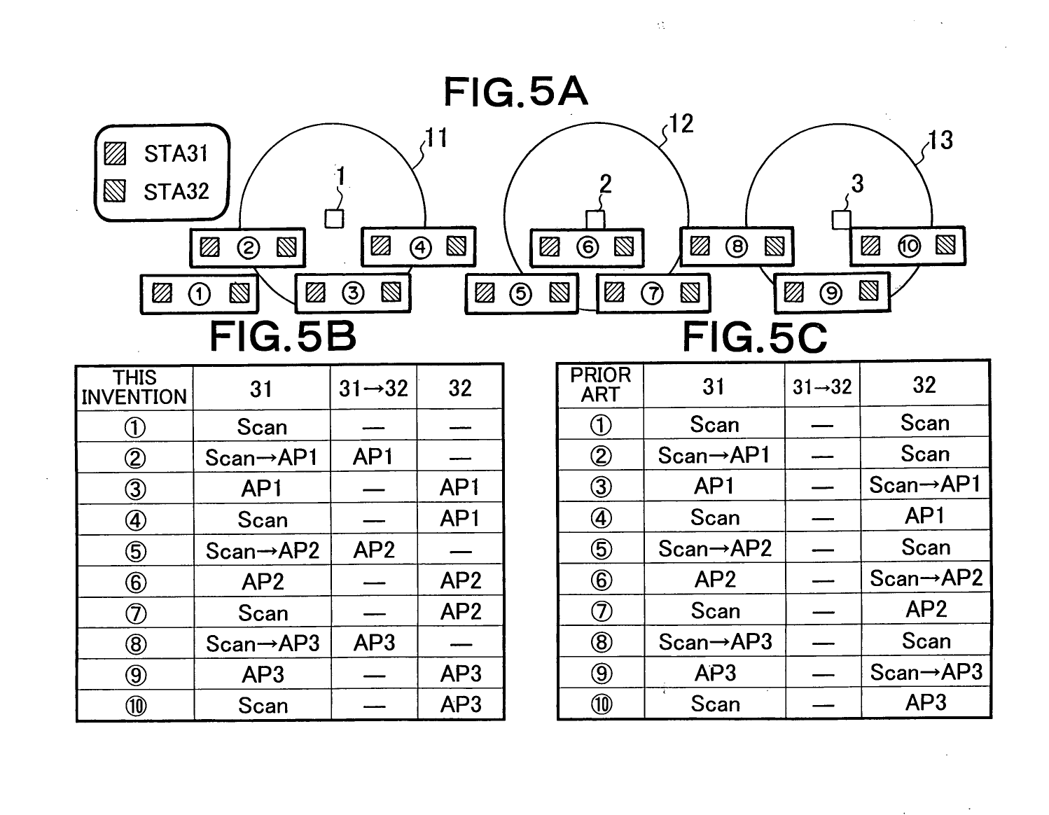

Now, the operation of the entire system will be described below. FIGS. 5A and 5B schematically illustrate how a mobile body 100 moves on a railroad. Now, how the belonging situation of the STA 31 and that of the STA 32 change as the mobile body 100 moves will be described below by referring to FIGS. 5A and 5B.

1: Since the STA 31 is not found in the cell of any access point, the STA 31 performs a Scanning operation, searching for an access point to which it is to belong to.

1→2: The STA 31 moves into cell 11. At this time, the STA 31 detects the beacon that the AP 1 transmits periodically by means of a Scanning operation and acquires information necessary for transmitting a belonging request to the AP 1 (the channel being used by the AP 1 and the identifier thereof). Then, the STA 31 transmits a belonging request according to the information it acquires and comes to belong to the AP 1. Additionally, the STA 31 notifies the STA 32 of the information acquired by the Scanning operation.

2→3: The STA 32 moves into the cell 11. Since the STA 32 has already been notified of the information necessary when it transmits a belonging request to the AP 1, it transmits a belonging request by means of the channel being used by the AP 1 and the identifier thereof without performing any Scanning operation and comes to belong to the AP 1. On the other hand, the STA 31 remains belonging to the AP 1.

3→4: The STA 31 moves out of the cell 11. As the STA 31 leaves the cell 11, it performs a Scanning operation, searching for an access point to which it is to belong to. On the other hand, the STA 32 remains belonging to the AP 1.

4→5: The STA 31 moves into cell 12. At this time, the STA 31 detects the beacon that the AP 2 transmits periodically by means of a Scanning operation and acquires information necessary for transmitting a belonging request to the AP 2 (the channel being used by the AP 2 and the identifier thereof. Then, the STA 31 transmits a belonging request according to the information it acquires and comes to belong to the AP 2. Additionally, the STA 31 notifies the STA 32 of the information acquired by the Scanning operation.

On the other hand, the STA 32 moves out of the cell 11 and comes into a state where it does not belong to any access point.

5→6: The STA 32 moves into the cell 12. Since the STA 32 has already been notified of the information necessary when it transmits a belonging request to the AP 2, from the STA 31, it transmits a belonging request by means of the channel being used by the AP 2 and the identifier thereof without performing any Scanning operation and comes to belong to the AP 2. On the other hand, the STA 31 remains belonging to the AP 1.

6→7: The STA 31 moves out of the cell 12. As the STA 31 leaves the cell 12, it performs a Scanning operation, searching for an access point to which it is to belong to. On the other hand, the STA 32 remains belonging to the AP 2.

7→8: The STA 31 moves into cell 13. At this time, the STA 31 detects the beacon that the AP 3 transmits periodically by means of a Scanning operation and acquires information necessary for transmitting a belonging request to the AP 3 (the channel being used by the AP 3 and the identifier thereof. Then, the STA 31 transmits a belonging request according to the information it acquires and comes to belong to the AP 3. Additionally, the STA 31 notifies the STA 32 of the information acquired by the Scanning operation.

On the other hand, the STA 32 moves out of the cell 12 and comes into a state where it does not belong to any access point.

8→9: The STA 32 moves into the cell 13. Since the STA 32 has already been notified of the information necessary when it transmits a belonging request to the AP 3, it transmits a belonging request by means of the channel being used by the AP 3 and the identifier thereof without performing any Scanning operation and comes to belong to the AP 3. On the other hand, the STA 31 remains belonging to the AP 3.

9→10: The STA 31 moves out of the cell 13. As the STA 31 leaves the cell 13, it performs a Scanning operation, searching for an access point to which it is to belong to. On the other hand, the STA 32 remains belonging to the AP 3.

In this way, the STA 31 that is arranged at the front side of the mobile body 100 as viewed in the moving direction of the mobile body notifies the STA 32 at the rear side of the information it acquires by means of a Scanning operation so that the STA 32 can belong to an access point without performing any Scanning operation.

### OPERATION EXAMPLE 1-2

Now, the second operation example of the communication system of this embodiment will be described below. While the individual operation of the STA 31 and that of the STA 32 are same as those of the first operation example, the STA 31 notifies the STA 32 of the AP information it acquires in response to a request from the STA 32. In other words, in the second operation example, the AP information is not push-delivered by the STA 31 but delivered in response to a pull by the STA 32.

Now, how the belonging situation of the STA 31 and that of the STA32 change as the mobile body 100 moves will be described below by referring to FIGS. 5A and 5B.

1: Since the STA 31 is not found in the cell of any access point, the STA 31 performs a Scanning operation, searching for an access point to which it is to belong to. Although the STA 32 requests the STA 31 to notify the information the latter acquires by means of the Scanning operation, no information is notified to it, because the STA 31 does not belong to any cell.

1→2: The STA 31 moves into cell 11. At this time, the STA 31 detects the beacon that the AP 1 transmits periodically by means of a Scanning operation and acquires information necessary for transmitting a belonging request to the AP 1 (the channel being used by the AP 1 and the identifier thereof. Then, the STA 31 transmits a belonging request according to the information it acquires and comes to belong to the AP 1. On the other hand, the STA 32 requests the STA 31 to notify the information the latter acquires by means of the Scanning operation. At this time, since the STA 31 acquires information on the AP 1 by the Scanning operation, the STA 32 is notified of the information relating to the AP 1.

2→3: The STA 32 moves into the cell 11. Since the STA 32 has already acquired the information necessary when it transmits a belonging request to the AP 1, it transmits a belonging request by means of the channel being used by the AP 1 and the identifier thereof without performing any Scan operation and comes to belong to the AP 1. On the other hand, the STA 31 remains belonging to the AP 1.

3→4: The STA 31 moves out of the cell 11. As the STA 31 leaves the cell 11, it performs a Scanning operation, searching for an access point to which it is to belong to. On the other hand, the STA 32 remains belonging to the AP 1.

4→5: The STA 31 moves into cell 12. At this time, the STA 31 detects the beacon that the AP 2 transmits periodically by means of a Scanning operation and acquires information necessary for transmitting a belonging request to the AP 2 (the channel being used by the AP 2 and the identifier thereof. Then, the STA 31 transmits a belonging request according to the information it acquires and comes to belong to the AP 2.

On the other hand, the STA 32 moves out of the cell 11 and comes into a state where it does not belong to any access point. Then, the STA 32 requests the STA 31 to notify the information the latter acquires by means of the Scanning operation. At this time, since the STA 31 acquires information on the AP 2 by the Scanning operation, the STA 32 is notified of the information relating to the AP 2.

5→6: The STA 32 moves into the cell 12. Since the STA 32 has already acquired the information necessary when it transmits a belonging request to the AP 2 from the STA 31, it transmits a belonging request by means of the channel being used by the AP 2 and the identifier thereof without performing any Scanning operation and comes to belong to the AP 2. On the other hand, the STA 31 remains belonging to the AP 2.

6→7: The STA 31 moves out of the cell 12. As the STA 31 leaves the cell 12, it performs a Scanning operation, searching for an access point to which it is to belong to. On the other hand, the STA 32 remains belonging to the AP 2.

7→8: The STA 31 moves into cell 13. At this time, the STA 31 detects the beacon that the AP 3 transmits periodically by means of a Scanning operation and acquires information necessary for transmitting a belonging request to the AP 3 (the channel being used by the AP 3 and the identifier thereof). Then, the STA 31 transmits a belonging request according to the information it acquires and comes to belong to the AP 3.

On the other hand, the STA 32 moves out of the cell 12 and comes into a state where it does not belong to any access point. Then, the STA 32 requests the STA 31 to notify the information the latter acquires by means of the Scanning operation. At this time, since the STA 31 acquires information on the AP 3 by the Scanning operation, the STA 32 is notified of the information relating to the AP 3.

8→9: The STA 32 moves into the cell 13. Since the STA 32 has already acquired the information necessary when it transmits a belonging request to the AP 3 from the STA 31, it transmits a belonging request by means of the channel being used by the AP 3 and the identifier thereof without performing any Scanning operation and comes to belong to the AP 3. On the other hand, the STA 31 remains belonging to the AP 3.

9→10: The STA 31 moves out of the cell 13. As the STA 31 leaves the cell 13, it performs a Scanning operation, searching for an access point to which it is to belong to. On the other hand, the STA 32 remains belonging to the AP 3.

In this way, the STA 32 that is arranged at the rear side of the mobile body 100 requests the STA 31 that is arranged at the front side to notify the information the latter acquires by means of a Scanning operation when it comes into a state where it does not belong to any access point so that the STA 32 can belong to an access point without performing any Scanning operation.

### OPERATION EXAMPLE 1-3

The STA 31 is adapted to notify the STA 32 of information on an AP after completing the process for belonging to the access point in the above-described operation examples. In this operation example, the STA 31 notifies the STA 32 of the progress of a Scanning operation for each channel in the course of the Scanning operation from time to time (Scan progress information). The flow of this operation will be described below.

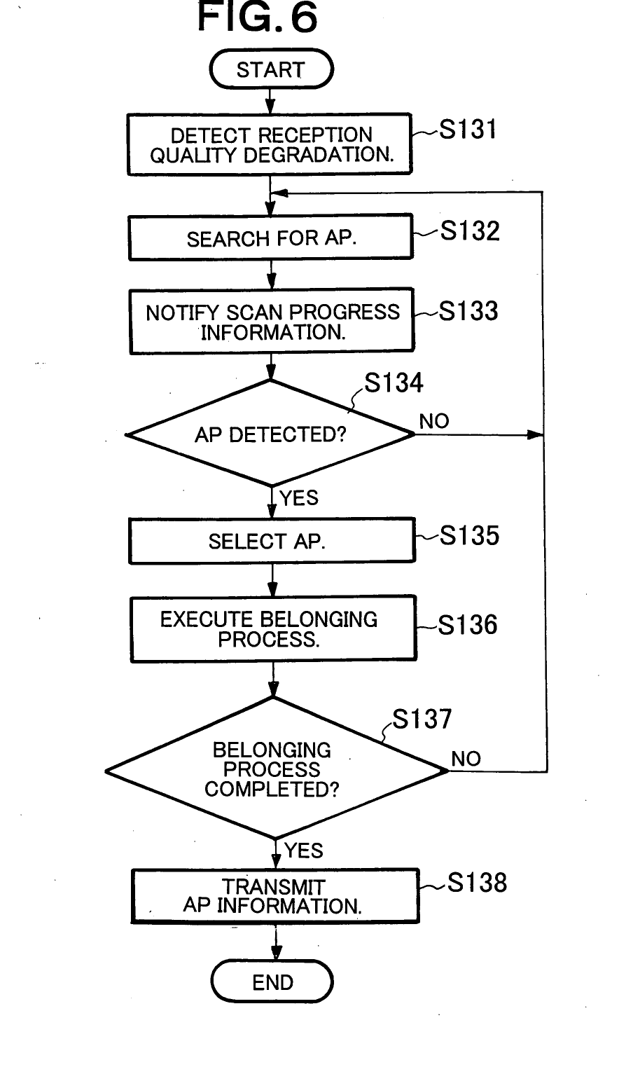

FIG. 6 is a flowchart of the operation of the STA 31 arranged at the front end of a mobile body. While this flow of the operation is substantially same as that of the first operation example, it differs from the latter in that the AP search section 312 notifies the STA 32 of the progress of the ongoing Scanning operation for each channel (Step S133).

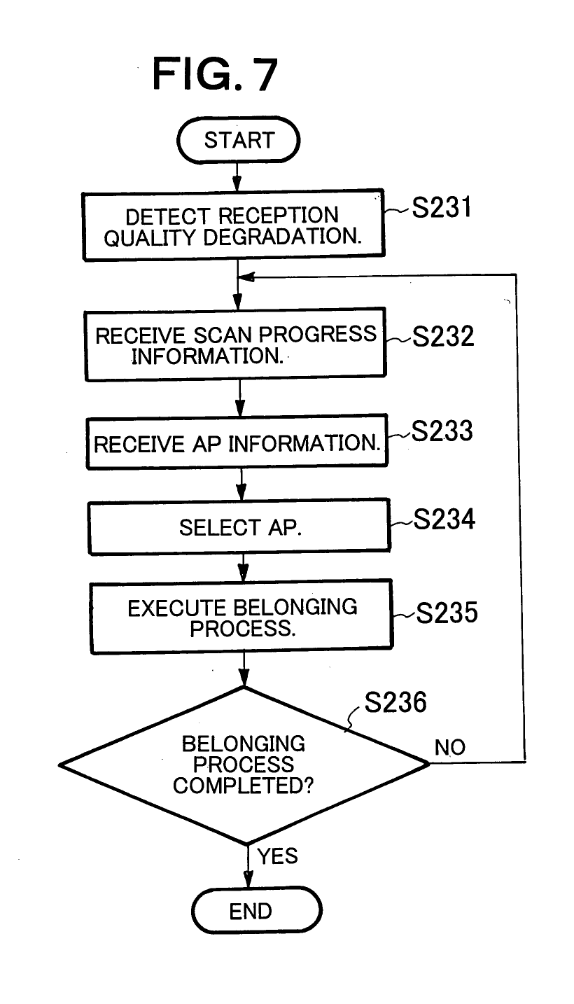

FIG. 7 is a flowchart of the operation of the STA 32 arranged at the rear end of a mobile body. While this flow of the operation is also substantially same as that of the first operation example, it differs from the latter in that it is notified by the STA 31 of Scan progress information before it receives AP information (Step S232)

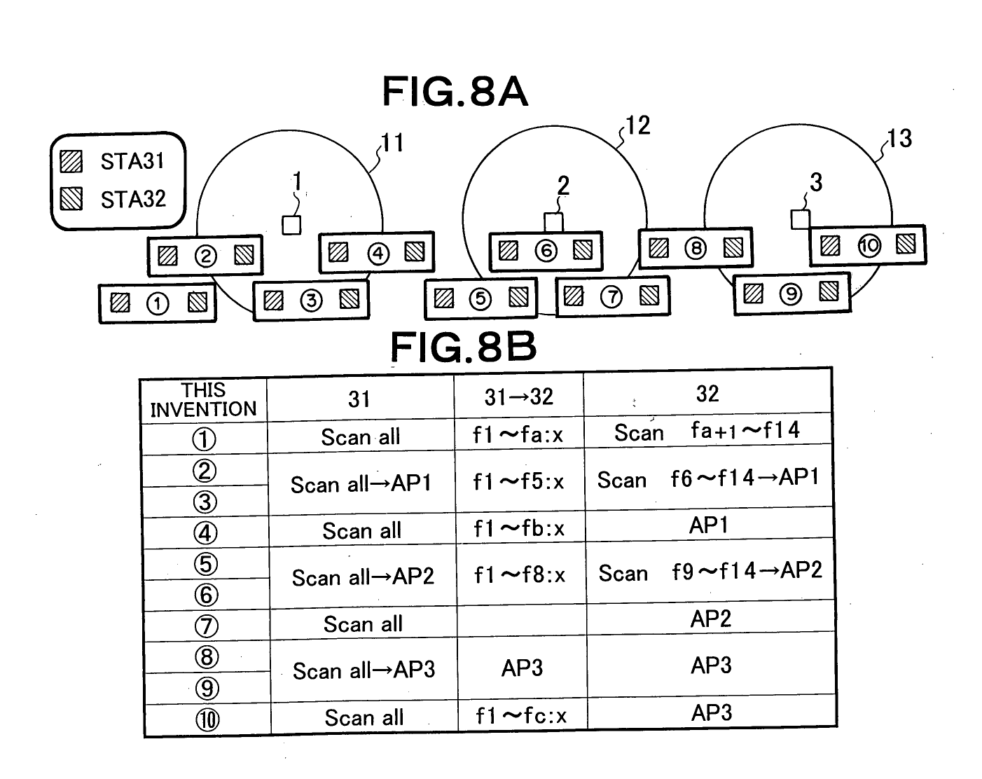

Now, the operation of the entire system will be described by referring to FIG. 8.

1: Since neither the STA 31 nor the STA 32 is found in the cell of any access point, the STA 31 performs a Scanning operation, searching for an access point to which it is to belong to. The STA 32 notifies the STA 32 of the progress of the Scanning operation for each channel. More specifically, if the STA 31 cannot detect the beacon of an access point through the channel through which it performs a Scanning operation, it notifies the STA 32 of the fact and then performs a Scanning operation through the second channel. Since the STA 31 is not found in the cell of any access point, it notifies the STA 32 of that it cannot detect any beacon through any of the channels it can use. When the STA 32 is notified of that the STA 31 cannot detect any beacon through any of the channels, it discards the Scan progress information notified to it.

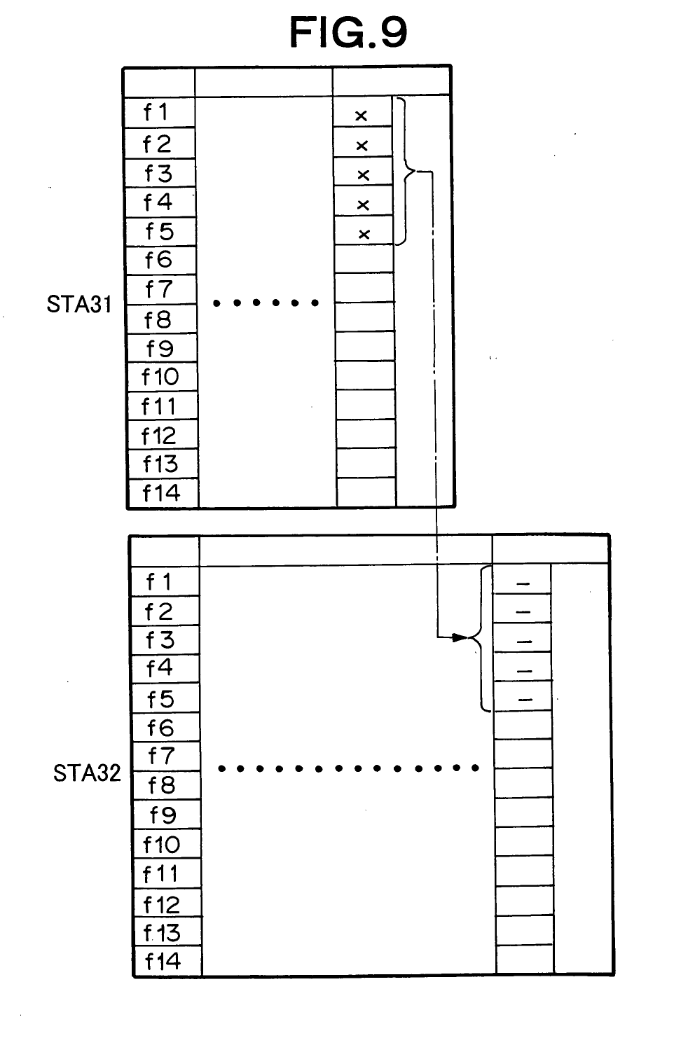

1→2→3: The STA 31 moves into cell 11 first. If the STA 31 performs a Scanning operation for the first through fifth channels and cannot detect any beacon until the mobile body 100 proceeds to position “3” as shown in FIG. 9, the STA 32 is notified of that the STA 31 has already finished the Scanning operation for the first through fifth channels. Therefore, the STA 32 does not perform any Scanning operation for the first through fifth channels but performs a Scanning operation only for the sixth through 14th channels.

As the STA 31 and the STA 32 detect a beacon as a result of the Scanning operation, they acquire information necessary for transmitting a belonging request to the AP 1 (the channel being used by the AP 1 and the identifier thereof). Then, the STA 31 and the STA 32 transmit a belonging request to the AP 1 according to the information they acquire and come to belong to the AP 1.

3→4: As the STA 31 moves out of the cell 11, it performs a Scanning operation, searching for a beacon. It also notifies the STA 32 of the progress of the Scanning operation for each channel. Since the STA 31 is not found in the cell of any access point when the mobile body 100 is at position “4”, it notifies the STA32 of that it cannot detect any beacon through any of the channels it can use. Since the STA 32 is notified of that the STA 31 cannot detect any beacon through any of the channels the latter has, it discards the notification of the progress of the Scanning operation for the channels.

4→5→6: The STA 31 moves into cell 12 first. If the STA 31 performs a Scanning operation for the first through eighth channels and cannot detect any beacon until the mobile body 100 proceeds to position “6”, the STA 32 is notified of that the STA 31 has already finished the Scanning operation for the first through eighth channels. Therefore, the STA 32 does not perform any Scanning operation for the first through eighth channels but performs a Scanning operation only for the ninth through 14th channels.

As the STA 31 and the STA 32 detect a beacon as a result of the Scanning operation, they acquire information necessary for transmitting a belonging request to the AP 2 (the channel being used by the AP 2 and the identifier thereof. Then, the STA 31 and the STA 32 transmit a belonging request to the AP 2 according to the information they acquire and come to belong to the AP 2.

6→7: As the STA 31 moves out of the cell 12, it performs a Scanning operation, searching for a beacon. It also notifies the STA 32 of the progress of the Scanning operation for each channel. Since the STA 31 is not found in the cell of any access point when the mobile body 100 is at position “7”, it notifies the STA32 of that it cannot detect any beacon through any of the channels it can use. Since the STA 32 is notified of that the STA 31 cannot detect any beacon through any of the channels the latter has, it discards the notification of the progress of the Scanning operation for the channels.

7→8→9: The STA 31 moves into cell 13 first. If the STA 31 has completed a Scanning operation and detected a beacon when the mobile body 100 gets to position “9”, the STA 32 is notified of the information necessary for transmitting a belonging request to the AP 3 (the channel being used by the AP 3 and the identifier thereof). Then, the STA 32 does not perform any Scanning operation but transmits a belonging request to the AP 3 and comes to belong to the AP 3.

9→10: As the STA 31 moves out of the cell 13, it performs a Scanning operation, searching for a beacon. It also notifies the STA 32 of the progress of the Scanning operation for each channel. Since the STA 31 is not found in the cell of any access point when the mobile body 100 is at position “10”, it notifies the STA32 of that it cannot detect any beacon through any of the channels it can use. Since the STA 32 is notified of that the STA 31 cannot detect any beacon through any of the channels the latter has, it discards the notification of the progress of the Scanning operation for the channels.

With the above-described flow of operation, since the STA that is arranged at the front side of the mobile body as viewed in the moving direction of the latter notifies at least part of the outcome of the Scanning operation it performs, the STA that is arranged at the rear side of the mobile body does not have to perform any or all Scanning operation. Thus, the time period that is required to be spent from the time when an STA moves into the cell of an access point to the time when it comes to belong to the access point is reduced. As a result, the efficiency of communication is improved.

Thus, this embodiment of communication system comprising a plurality of stations are mounted on a mobile body and adapted to utilize a LAN can improve the efficiency of communication for at least part of the stations.

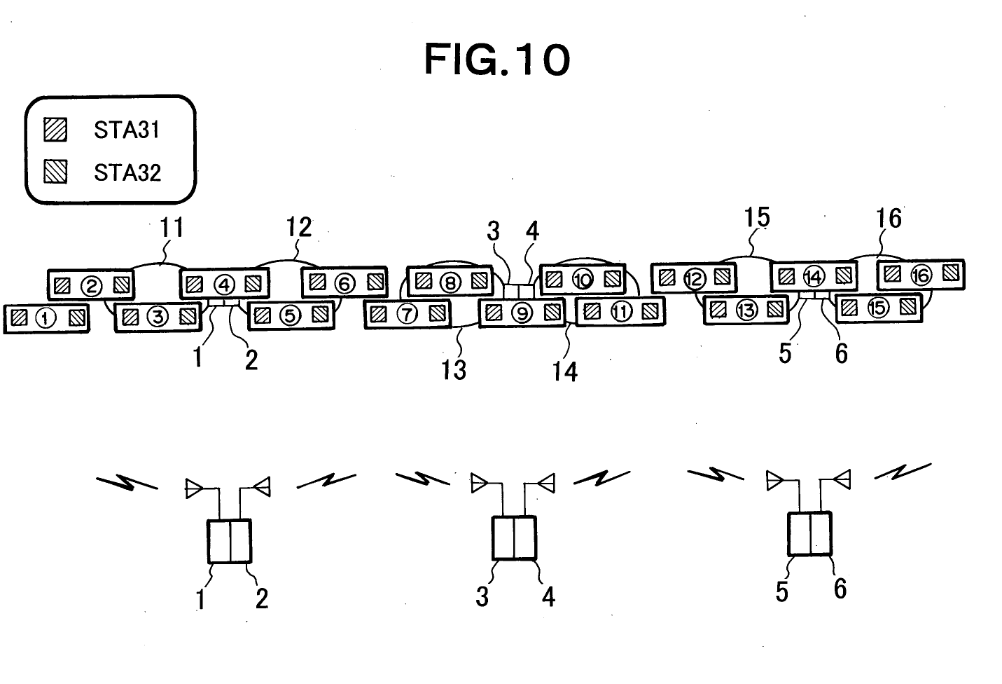

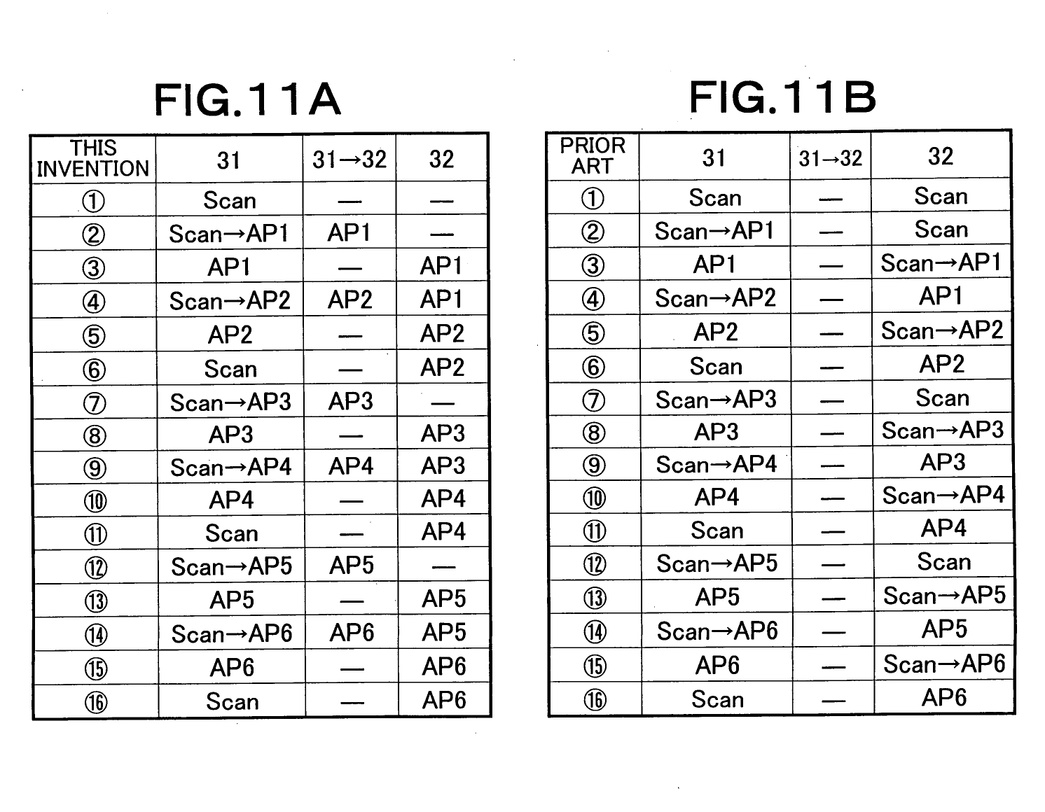

While the access points do not have any communication directivity in the above examples, the present invention is also applicable to access points that have communication directivity as shown in FIGS. 10 and 11.

### Second Embodiment

Now, the second embodiment of the present invention that suitably embodies the present invention will be described below. The overall configuration of this embodiment of communication system is substantially identical with that of the first embodiment.

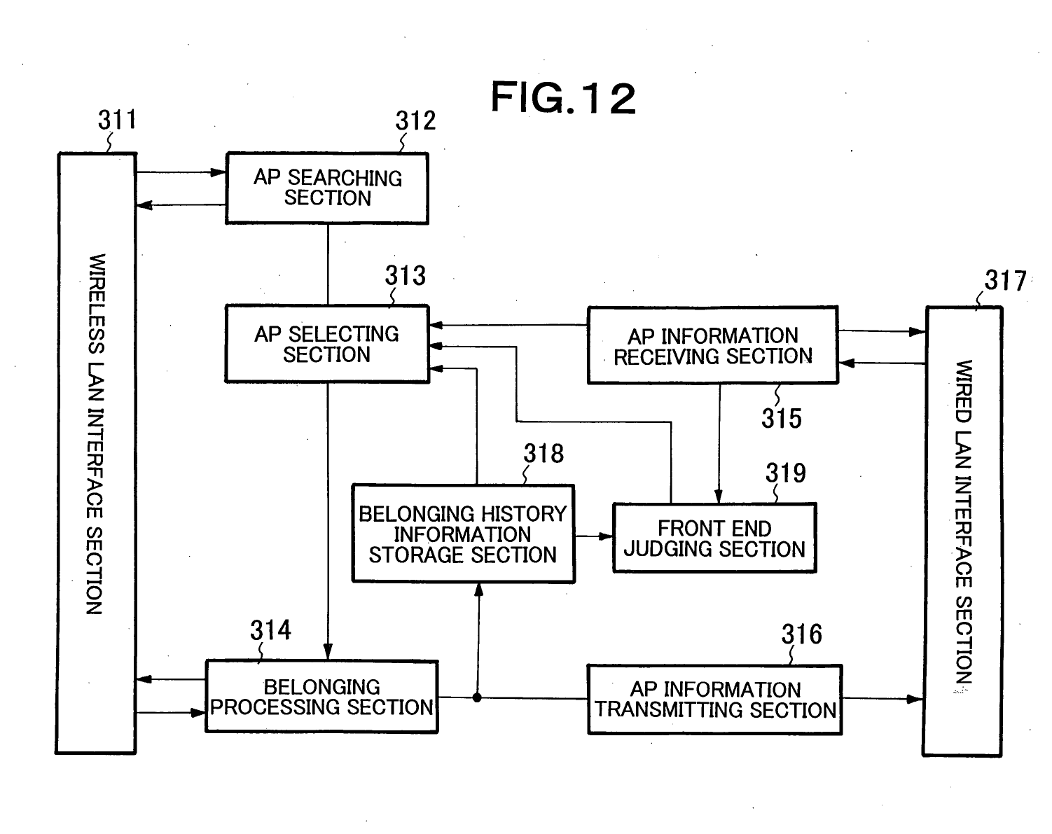

FIG. 12 shows a station apparatus of the second embodiment. The station apparatus of this embodiment is identical with a station apparatus that is applicable to the first embodiment of communication system except that it additionally comprises a belonging history information storage section 318 and a front end judging section 319.

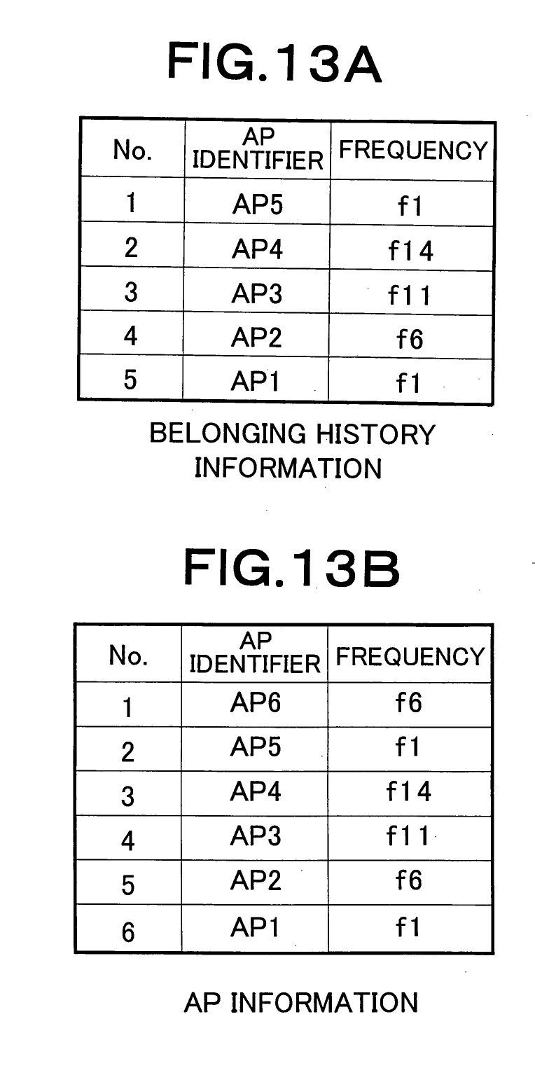

The belonging history information storage section 318 stores the access point or points to which the station apparatus has belonged and the outcome of the Scanning operations that have been performed so far. FIG. 13A is a chart of the information that may be stored in the belonging history information storage section 318 of the second embodiment, illustrating belonging history information. The front end judging section 319 executes a processing operation of judging if the own apparatus is arranged at the front end of the mobile body 100 on which it is mounted or not.

In this embodiment, which of the STA 31 and the STA 32 is arranged at the front end of the mobile body 100 as viewed in the moving direction of the latter is not defined in advance. In other words, neither the STA 31 nor the STA 32 knows which of them has to notify the other of the AP information it has.

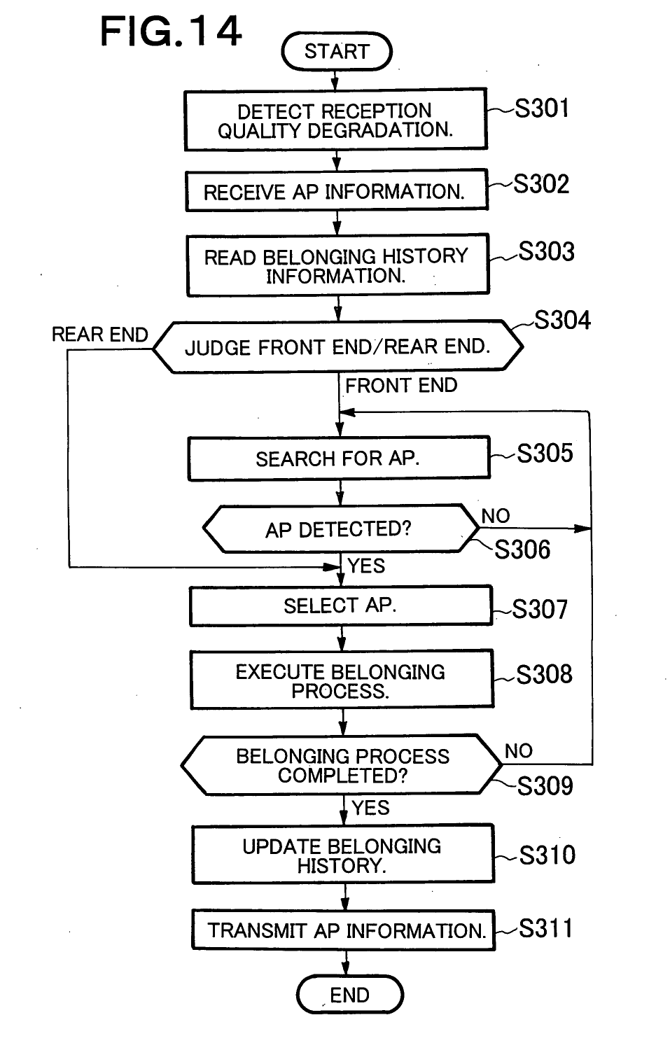

Firstly, the operation of each of the STAs will be described below. FIG. 14 shows a flow of the processing operation of an STA. While both the STA 31 and the STA 32 operate in the same way, the operation of the STA 31 will be described below.

If the STA 31 cannot wirelessly communicate with any access point with a predetermined quality of signal reception (including a situation where no communication is established with any access point) (Step S301), it compares the most updated AP information notified by the STA 32 and the information it reads out from the belonging history information storage section 318 and judges if the own apparatus is arranged at the front end side of the mobile body 100 or not (Step S302 through 304). A specific example of processing operation for judging if the own apparatus is arranged at the front end or not will be described in greater detail hereinafter.

If the STA 31 judges that the own apparatus is arranged at the front end of the mobile body 100 (Step S304/front end), it executes a processing operation similar to that of Steps S102 through S107 of the first embodiment. After completing the process of belonging to an access point, the STA 31 stores AP information on the access point to which it newly comes to belong to (Step S310). Thereafter, it notifies the STA 32 of the AP information and ends the processing operation (Step S311).

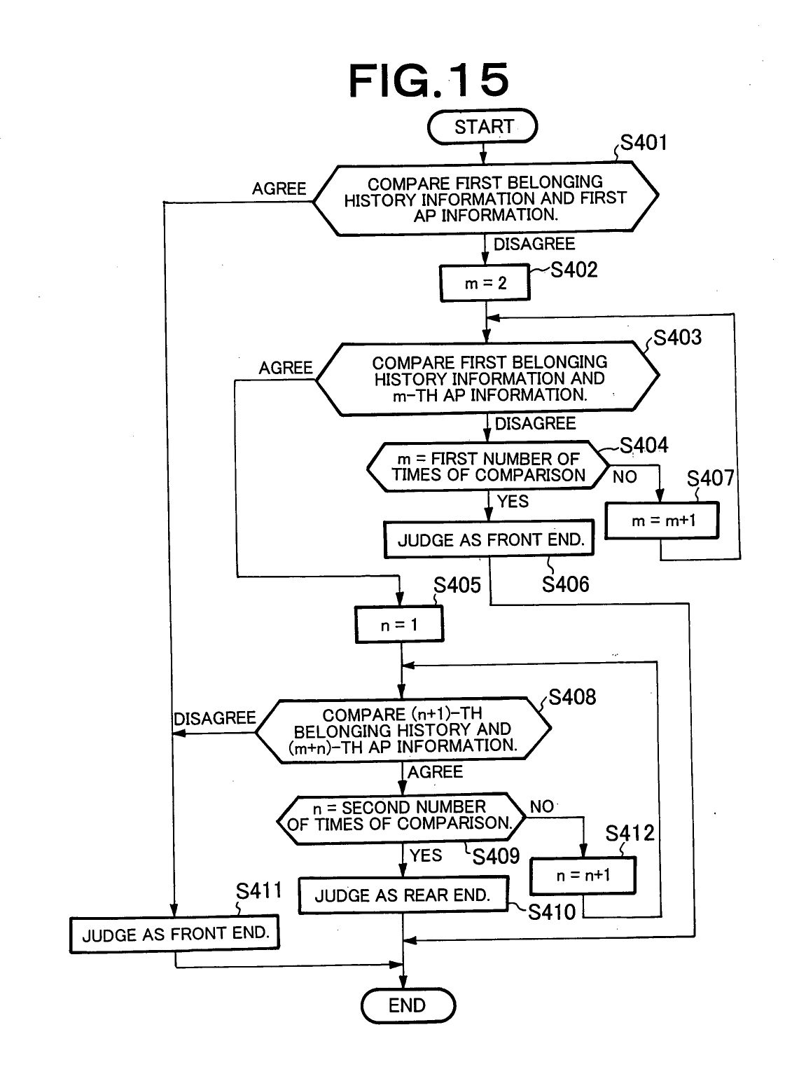

Then, the processing operation by means of which each of the STAs judges if the own apparatus is arranged at the front end of the mobile body 100 or not will be described below. FIG. 15 shows a flow of the processing operation. Firstly, the front end judging section 319 compares the first piece (in other words, the most updated piece) of belonging history with the first piece (or the most updated piece) of AP information (Step S401). If they agree with each other (Step S401/agree), the front end judging section 319 judges that the own apparatus is arranged at the front end (Step S411). If, on the other hand, they do not agree with each other (Step S401/disagree), the front end judging section 319 selects “2” for the first variable (which is expressed by “m” in FIG. 15) (Step S402). Subsequently, the front end judging section 319 compares the first piece of belonging history with the m-th piece (“2nd” piece) of AP information it acquires from the STA 32 (Step S403).

If the first piece of belonging information and the m-th piece of belonging information do not agree with each other (Step S403/disagree), the front end judging section 319 judges if the value of the first variable m and the first number of times of comparison (a predefined value that is a natural number not smaller than 2) agree with each other or not (Step S404).

If the value of the first variable m and the first number of times of comparison agree with each other (Step S404/Yes), the front end judging section 319 increments the value of the first variable m by “1” (Step S407) and subsequently compares the first piece of belonging history and the m-th piece of AP information (Step S403). When the front end judging section 319 cannot find a piece of AP information that agrees with the first piece of belonging information until the value of the first variable m gets to the number of times of comparison, the front end judging section 319 judges that the own apparatus is arranged at the front end of the mobile body 100 (Step S406).

If, on the other hand, the first piece of belonging information and the m-th piece of AP information agree with each other (Step S403/agree), the front end judging section 319 judges that the own apparatus can be arranged at the rear end of the mobile body 100 and selects “1” for the value of the second variable (which is expressed by “n” in FIG. 15) (Step S405). Subsequently, the front end judging section 319 compares the n+1-th piece of belonging history and the m+n-th piece of AP information (Step S408). If they agree with each other (Step S408/agree), the front end judging section 319 then judges if the value of the second variable n and the second number of times of comparison (a predefined value that is a natural number not smaller than 2) agree with each other or not (Step S409).

If the value of the second variable n and the second number of times of comparison do not agree with each other (Step S409/No), the front end judging section 319 increments the value of the second variable n by “1” (Step S412) and subsequently compares the n+1-th piece of belonging history and the m+n-th piece of AP information (Step S408).

If there are a piece of belonging history and a piece of AP information that do not agree with each other while the front end judging section 319 is comparing the n+1-th piece of belonging history and the m+n-th piece of AP information (Step S408/disagree) for the second number of times of comparison, the front end judging section 319 judges that the own apparatus is arranged at the front end of the mobile body 100 (Step S411).

If, on the other hand, all the comparisons where the front end judging section 319 compares n+1-th piece of belonging history and the m+n-th piece of AP information for the second number of times of comparison result in agreement (Step S409/Yes), the front end judging section 319 judges that the own apparatus is arranged at the rear end of the mobile body 100. As a result, the AP selecting section 313 selects the base station of the m−1-th piece of AP information as the addressee to whom a belonging request is to be transmitted.

As the front end judging section 319 repeats the operation of comparing the first piece belonging information and the m-th piece of AP information for the predetermined number of times (or until the value of m agree with the first number of times of comparison in the flowchart of FIG. 15), it can judge if the own apparatus can be arranged at the rear end of the mobile body 100 or not even if the mobile body 100 on which a front end STA, an intermediate STA and a rear end STA are arranged extends over three or more than three access points.

If the own apparatus can be arranged at the rear end of the mobile body 100, the front end judging section 319 compares a piece of belonging history with pieces of AP information for the second number of times of comparison and, if all the comparisons result in agreement, it can safely judge that the own apparatus is arranged at the rear end of the mobile body 100. When the front end judging section 319 judges that the own apparatus is arranged at the rear end of the mobile body 100, the AP selecting section 313 can safely select the access point of the m−1-th piece of AP information as the addressee to whom a belonging request is to be transmitted. Then, since it has already acquired the information necessary for transmitting a belonging request (the frequency being used by the AP and the identifier thereof, the belonging processing section 314 can quickly complete a belonging process as the STA 31 moves into the cell to which it is to belong to.

### OPERATION EXAMPLE 2-1

Now, the first operation example of the communication system of this embodiment will be described below. Firstly, how the telecommunicating conditions of the STA 31 and those of the STA 32 change as the mobile body 100 moves will be discussed.

1: Since neither the STA 31 nor the STA 32 belongs to any access point, they access the information stored respectively in the belonging history information storage section 328 and the belonging history information storage section 318 of the partner stations and refer to the own communication history and the belonging history of the partner STAs. In this instance, each of the STAs confirms that both of the STAs do not have any communication history. Then, each of the STAs performs a Scanning operation, searching for an access point to which it can belong to.

1→2: The STA 31 moves into cell 11. At this time, the STA 31 detects the beacon that the AP 1 transmits periodically by means of a Scanning operation and acquires information necessary for transmitting a belonging request to the AP 1 (the channel being used by the AP 1 and the identifier thereof). Then, the STA 31 transmits a belonging request according to the information it acquires and comes to belong to the AP 1. Thereafter, the STA 31 registers the information indicating that it comes to belong to AP 1 and the information indicating the channel being used by the AP 1 and the identifier thereof to the belonging history information storage section 318.

Since the STA 32 does not belong to any access point, it repeats an operation of referring to the information stored in the belonging history information storage sections 318 and 328 and subsequently performing a Scanning operation. However, after the STA 31 registers the information that it comes to belong to the AP 1 to the belonging history information storage section 318, it performs a Scanning operation sequentially for the channels, starting from the channel that the AP 1 is using.

2→3: The STA 32 moves into the cell 11. Since the STA 32 performs a Scanning operation for the channel that the AP 1 is using first, it detects the beacon of the AP 1 in the first Scanning operation. Then, the STA 32 transmits a belonging request to the AP 1 and comes to belong to the AP 1. Thereafter, the STA 32 registers the information indicating that it comes to belong to AP 1 and the information indicating the channel being used by the AP 1 and the identifier thereof to the belonging history information storage section 328.

3→4: The STA 31 moves out of the cell 11. As the STA 31 leaves the cell 11, it accesses the information stored in the belonging history information storage sections 318 and 328 and refers to the communication history of the own apparatus and that of the other STA. The STA 31 compares the history of the own apparatus and that of the STA 32 and performs an ordinary Scanning operation because the STA 32 comes to belong to the AP 1 after the STA 31.

4→5: The STA 31 moves into cell 12. At this time, the STA 31 detects the beacon that the AP 2 transmits periodically by means of a Scanning operation and acquires information necessary for transmitting a belonging request to the AP 2 (the channel being used by the AP 2 and the identifier thereof. Then, the STA 31 transmits a belonging request according to the information it acquires and comes to belong to the AP 2. Thereafter, the STA 31 registers the information indicating that it comes to belong to AP 2 and the information indicating the channel being used by the AP 2 and the identifier thereof to the belonging history information storage section 318.

On the other hand, since the STA 32 moves out of the cell 11 and does not belong to any access point, it refers to the information stored in the belonging history information storage sections 318 and 328 and grasps that the STA 31 that came to belong to the AP 1 before the own apparatus now comes to belong to the AP 2. Therefore, the STA 32 transmits a belonging request by means of the channel being used by the AP 2 and the identifier thereof before it performs a Scanning operation and, if it does not receive any response to the request, it repeats the Scanning operation sequentially for the channels, starting from the channel that the AP 2 is using.

5→6: The STA 32 moves into the cell 12. Since the STA 32 transmits a belonging request by means of the channel being used by the AP 2 and the identifier thereof before it performs a Scanning operation, it comes to belong to the AP 2 without performing a Scanning operation after moving into the cell 12. Thereafter, the STA 32 registers the information indicating that it comes to belong to AP 2 and the information indicating the channel being used by the AP 2 and the identifier thereof to the belonging history information storage section 328.

6→7: The STA 31 moves out of the cell 12. As the STA 31 leaves the cell 12, it accesses the information stored in the belonging history information storage sections 318 and 328 and refers to the communication history of the own apparatus and that of the other STA. The STA 31 compares the history of the own apparatus and that of the STA 32 and performs an ordinary Scanning operation because the STA 32 comes to belong to the AP 1 and the AP 2 after the STA 31.

7→8: The STA 31 moves into cell 13. At this time, the STA 31 detects the beacon that the AP 3 transmits periodically by means of a Scanning operation and acquires information necessary for transmitting a belonging request to the AP 3 (the channel being used by the AP 3 and the identifier thereof. Then, the STA 31 transmits a belonging request according to the information it acquires and comes to belong to the AP 3. Thereafter, the STA 31 registers the information indicating that it comes to belong to AP 3 and the information indicating the channel being used by the AP 3 and the identifier thereof to the belonging history information storage section 318.

On the other hand, since the STA 32 moves out of the cell 12 and does not belong to any access point, it refers to the information stored in the belonging history information storage sections 318 and 328 and grasps that the STA 31 that came to belong to the AP 1 and the AP 2 before the own apparatus now comes to belong to the AP 3. Therefore, the STA 32 transmits a belonging request by means of the channel being used by the AP 3 and the identifier thereof before it performs a Scanning operation and, if it does not any response to the request, it repeats the Scanning operation sequentially for the channels, starting from the channel that the AP 3 is using.

8→9: The STA 32 moves into the cell 13. Since the STA 32 transmits a belonging request by means of the channel being used by the AP 3 and the identifier thereof before it performs a Scanning operation, it comes to belong to the AP 3 without performing a Scanning operation after moving into the cell 13. Thereafter, the STA 32 registers the information indicating that it comes to belong to AP 3 and the information indicating the channel being used by the AP 3 and the identifier thereof to the belonging history information storage section 328.

9→10: The STA 31 moves out of the cell 13. As the STA 31 leaves the cell 13, it accesses the information stored in the belonging history information storage sections 318 and 328 and refers to the communication history of the own apparatus and that of the other STA. The STA 31 compares the history of the own apparatus and that of the STA 32 and performs an ordinary Scanning operation because the STA 32 comes to belong to the AP 1, the AP 2 and the AP 3 after the STA 31.

With the above-described operation, each of the STAs can recognize if it is arranged at the front end or the rear end of the mobile body 100 according to the belonging history of each of the STAs although it is not defined in advance if each of the STAs is arranged at the front end or the rear end of the mobile body as viewed in the moving direction of the latter. As a result, the STA that is arranged at the rear end of the mobile body as viewed in the moving direction of the latter can reduce the time necessary for switching access points to improve the efficiency of communication.

While the STA arranged at the rear side of the mobile body refers to the belonging history of the STA that came to belong to the access point before itself to which it has been belonging and predicts the access point to which it comes to belong next in the above-described operation example, it is not necessarily limited thereto. For example, it may alternatively be so arranged that the STA compares its own belonging history and that of the other history for a predetermined number of different access points to which it and the other STA belonged (e.g., five different access points) and predicts to be belonging to the cell same as the other STA if they belonged to the same access points, the number of which is not smaller than a predetermined number (e.g., four).

### OPERATION EXAMPLE 2-2

Now, the second operation example of the communication system of this embodiment will be described by referring to FIG. 8.

1: Since neither the STA 31 nor the STA 32 is found in the cell of any access point, each of the STA 31 and the STA 32 performs a Scanning operation, searching for an access point to which each of them is to belong to. Each of the STA 31 and the STA 32 registers the outcome of the Scanning operation for each channel in the belonging history information storage section 318 or 328 that belongs to it. More specifically, if each of the STAs cannot detect a beacon by way of the channel for which it firstly performs a Scanning operation, it registers the fact to the belonging history information storage section 318 or 328 that belongs to it and subsequently performs a Scanning operation for the second channel. Since neither the STA 31 nor the STA 32 is found in the cell of any access point in this instance, they register the fact that they cannot detect any beacon to the respective belonging history information storage sections 318, 328. The information that neither the STA 31 not the STA 32 belongs to any cell is registered to the belonging history information storage sections 318, 328 as communication history of the STAs according to the outcome of the Scanning operation for all the channels.

1→2→3: The STA 31 moves into cell 11 first. The STA 31 accesses the information stored in the belonging history information storage sections 318, 328 and refers to the belonging history of the own apparatus and that of the other STA. Since neither the STA 31 nor the STA 32 belongs to any cell in this instance, the STA 31 performs an ordinary Scanning operation. If the STA 31 has performed a Scanning operation for the first through fifth channels by the time when the mobile body 100 enters to position “3”, the information indicating that the Scanning operation has been performed for the first through fifth channels and no beacon has been detected is registered to the belonging history information storage section 318.

On the other hand, the STA 32 accesses the information stored in the belonging history information storage sections 318 and 328 before it performs a Scanning operation. Since neither the STA 31 nor the STA 32 belongs to any access point by the time when the mobile body 100 is at position “3”, the STA 32 refers to the information relating to the outcome of the Scanning operation of the STA 31 that is stored in the belonging history information storage section 318. Since the information indicating that the STA 31 has performed a Scanning operation for the first through fifth channels but no beacon has been found so far is registered in this instance, the STA 32 grasps that it cannot detect any beacon if it performs a Scanning operation for the first through fifth channels. Therefore, the STA 32 performs a Scanning operation only for the sixth through 14th channels without performing any Scanning operation for the first through fifth channels.

The STA 31 and the STA 32 that have detected a beacon by means of a Scanning operation acquire information necessary for transmitting a belonging request to the AP 1 (the channel being used by the AP 1 and the identifier thereof. Then, the STA 31 and the STA 32 transmit a belonging request according to the information they acquire and come to belong to the AP 1. Then, the STAs register the information indicating that they come to belong to the AP 1 respectively in the belonging history information storage sections 318 and 328.

3→4: The STA 31 moves out of the cell 11. As the STA 31 leaves the cell 11, it accesses the information stored in the belonging history information storage sections 318 and 328 and refers to the communication history of the own apparatus and that of the other STA. The STA 31 compares the history of the own apparatus and that of the STA 32 and performs an ordinary Scanning operation because the STA 32 comes to belong to the AP 1 after the STA 31. Then, the STA 31 registers the outcome of the Scanning operation for each channel in the belonging history information storage section 318. Since the STA 31 is not found in the cell of any access point when the mobile body 100 is at position “4”, the information indicating that it cannot detect any beacon for all the channels is registered to the belonging history information storage section 318. Then, the STA 31 stores the information indicating that it does not belong to any cell in the belonging history information storage section 318 according to the outcome of the Scanning operation it performs for all the channels.

4→5→6: The STA 31 moves into cell 12 first. If the STA 31 has performed a Scanning operation for the first through eighth channels by the time when the mobile body 100 enters to position “6”, the information indicating that the Scanning operation has been performed for the first through eighth channels and no beacon has been detected is already registered to the belonging history information storage section 318. Therefore, the STA 32 grasps that it cannot detect any beacon if it performs a Scanning operation for the first through eighth channels when it accesses the information stored in the belonging history information storage sections 318 and 328 before it actually performs a Scanning operation. Thus, the STA 32 performs a Scanning operation only for the ninth through 14th channels without performing any Scanning operation for the first through eighth channels.

The STA 31 and the STA 32 that have detected a beacon by means of a Scanning operation acquire information necessary for transmitting a belonging request to the AP 2 (the channel being used by the AP 2 and the identifier thereof). Then, the STA 31 and the STA 32 transmit a belonging request according to the information they acquire and come to belong to the AP 2. Then, the STAs register the information indicating that they come to belong to the AP 2 respectively in the belonging history information storage sections 318 and 328.

6→7: The STA 31 moves out of the cell 12. As the STA 31 leaves the cell 11, it accesses the information stored in the belonging history information storage sections 318 and 328 and refers to the communication history of the own apparatus and that of the other STA. The STA 31 compares the history of the own apparatus and that of the STA 32 and performs an ordinary Scanning operation because the STA 32 comes to belong to the AP 1 and the AP 2 after the STA 31. Then, the STA 31 registers the outcome of the Scanning operation for each channel in the belonging history information storage section 318. Since the STA 31 is not found in the cell of any access point when the mobile body 100 is at position “7”, the information indicating that it cannot detect any beacon for all the channels is registered to the belonging history information storage section 318. Then, the STA 31 stores the information indicating that it does not belong to any cell in the belonging history information storage section 318 according to the outcome of the Scanning operation it performs for all the channels.

7→8→9: The STA 31 moves into cell 13 first. If the STA 31 has completed a Scanning operation for all the channels by the time when the mobile body 100 enters to position “9” and finished detecting a beacon, the information indicating that the STA 31 has belonged to AP 3 and the information necessary for belonging to the AP 3 (the channel being used by the AP 3 and the identifier thereof) are registered to the belonging history information storage section 318. Thus, the STA 32 can acquire the channel being used by the AP 3 and the identifier thereof before it moves into the cell 13 by referring to the information stored in the belonging history information storage sections 318 and 328. Therefore, the STA 32 transmits a belonging request to the AP 3 and comes to belong to the AP 3 without performing any Scanning operation.

9→10: The STA 31 moves out of the cell 13. As the STA 31 leaves the cell 13, it accesses the information stored in the belonging history information storage sections 318 and 328 and refers to the communication history of the own apparatus and that of the other STA. The STA 31 compares the history of the own apparatus and that of the STA 32 and performs an ordinary Scanning operation because the STA 32 comes to belong to the AP 1, the AP 2 and the AP 3 after the STA 31. Then, the STA 31 registers the outcome of the Scanning operation for each channel in the belonging history information storage section 318. Since the STA 31 is not found in the cell of any access point when the mobile body 100 is at position “10”, the information indicating that it cannot detect any beacon for all the channels is registered to the belonging history information storage section 318. Then, the STA 31 stores the information indicating that it does not belong to any cell in the belonging history information storage section 318 according to the outcome of the Scanning operation it performs for all the channels.

With the above-described flow of operation, since the STA that is arranged at the front side of the mobile body as viewed in the moving direction of the latter notifies at least part of the outcome of the Scanning operation it performs, the STA that is arranged at the rear side of the mobile body does not have to perform any or all of the Scanning operation. Thus, the time period that is required to be spent from the time when an STA moves into the cell of an access point to the time when it comes to belong to the access point is reduced. As a result, the efficiency of communication is improved.

This embodiment of communication system can suitably be used for a mobile body that can move forwardly and backwardly such as railway trains because it is not necessary to define the moving direction of each STA.

### Third Embodiment

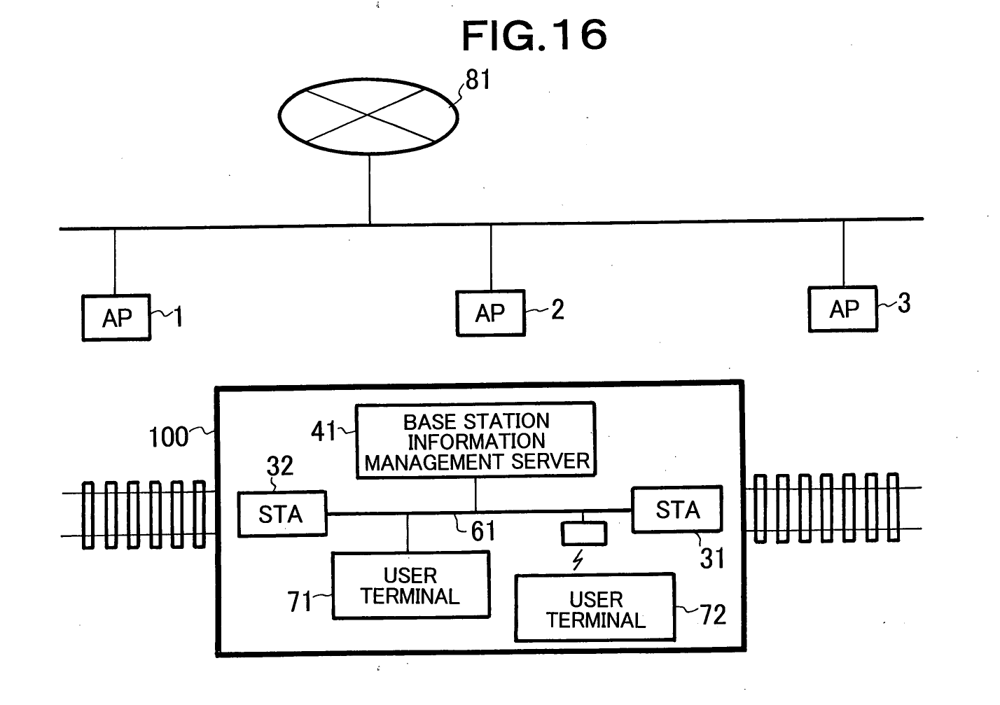

Now, the third embodiment of the present invention that suitably embodies the present invention will be described below. FIG. 16 is a schematic block diagram of the third embodiment of communication system according to the invention, showing the configuration thereof. This embodiment of communication system is substantially identical with the first embodiment except that it further comprises a base station information management server 41. However, as in the second embodiment, which of the STA 31 and the STA 32 is arranged at the front end of the mobile body 100 as viewed in the moving direction of the latter is not defined in advance in this embodiment. In other words, neither the STA 31 nor the STA 32 knows which of them is arranged at the front end of the mobile body.

The access information management server 41 stores information relating to the communication history of each station (information indicating the access point or points to which the station has belonged to).

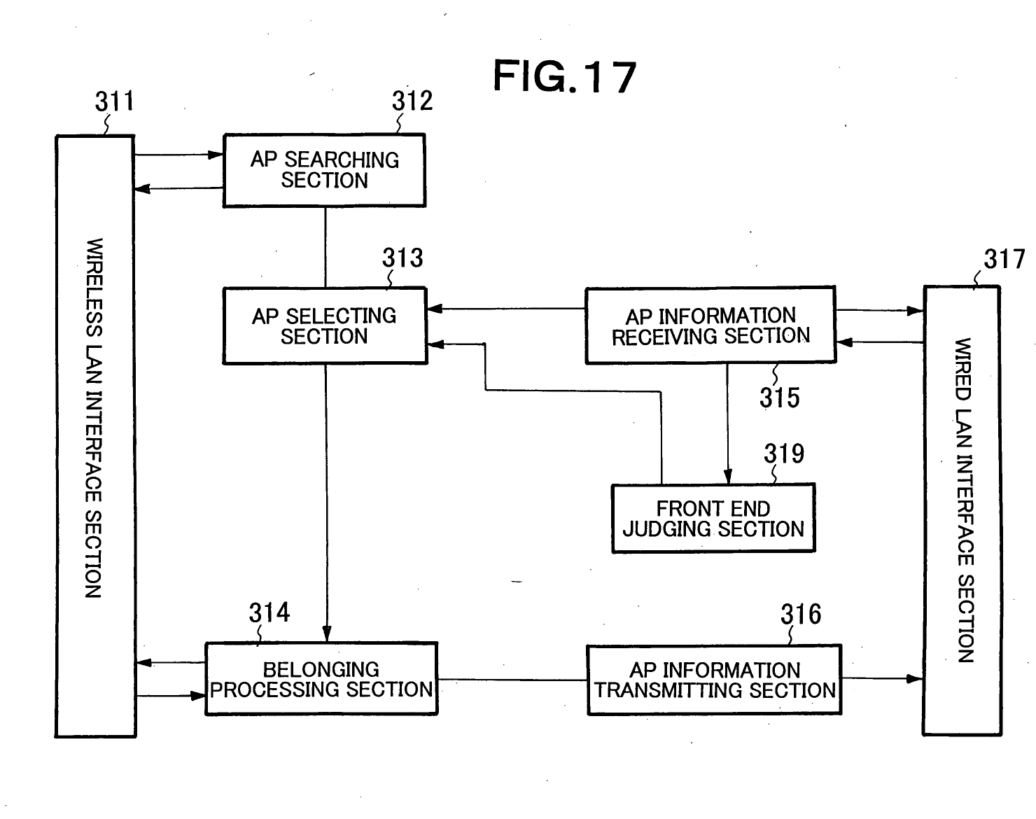

FIG. 17 shows the configuration of the STA 31. If compared with the STA 31 of the first embodiment, the STA 31 of this embodiment additionally comprises a front end judging section 319.

The front end judging section 319 judges if the own apparatus is arranged at the front end of the mobile body 100 or not by executing a process similar to that of the second embodiment. However, it differs from its counterpart of the second embodiment in that it executes the process according to the information stored in the base station information management server 41.

### OPERATION EXAMPLE 3-1

Now, the first operation example of the communication system of this embodiment will be described below. Firstly, how the communicating conditions of the STA 31 and those of the STA 32 change as the mobile body 100 moves will be discussed with reference to FIG. 15A.

1: Since neither the STA 31 nor the STA 32 belongs to any access point, they access the information stored in the base station information management server 41 and refer to the own communication history and the communication history of the partner STAs. In this instance, each of the STAs confirms that both of the STAs do not have any communication history. Then, each of the STAs performs a Scanning operation, searching for an access point to which it can belong to.

1→2: The STA 31 moves into cell 11. At this time, the STA 31 detects the beacon that the AP 1 transmits periodically by means of a Scanning operation and acquires information necessary for transmitting a belonging request to the AP 1 (the channel being used by the AP 1 and the identifier thereof). Then, the STA 31 transmits a belonging request according to the information it acquires and comes to belong to the AP 1.

Thereafter, the STA 31 registers the information indicating that it comes to belong to AP 1 and the information indicating the channel being used by the AP 1 and the identifier thereof to the base station information management server 41.

Since the STA 32 does not belong to any access point, it repeats an operation of referring to the information stored in the base station information management server 41 and subsequently performing a Scanning operation. However, after the STA 31 registers the information that it comes to belong to the AP 1, it performs a Scanning operation sequentially for the channels, starting from the channel that the AP 1 is using.

2→3: The STA 32 moves into the cell 11. Since the STA 32 performs a Scanning operation for the channel that the AP 1 is using first, it detects the beacon of the AP 1 in the first Scanning operation. Then, the STA 32 transmits a belonging request to the AP 1 and comes to belong to the AP 1. Thereafter, the STA 32 registers the information indicating that it comes to belong to AP 1 and the information indicating the channel being used by the AP 1 and the identifier thereof to the base station information management server 41.

3→4: The STA 31 moves out of the cell 11. As the STA 31 leaves the cell 11, it accesses the information stored in the base station information management server 41 and refers to the communication history of the own apparatus and that of the other STA. The STA 31 compares the history of the own apparatus and that of the STA 32 and performs an ordinary Scanning operation because the STA 32 comes to belong to the AP 1 after the STA 31.

4→5: The STA 31 moves into cell 12. At this time, the STA 31 detects the beacon that the AP 2 transmits periodically by means of a Scanning operation and acquires information necessary for transmitting a belonging request to the AP 2 (the channel being used by the AP 2 and the identifier thereof. Then, the STA 31 transmits a belonging request according to the information it acquires and comes to belong to the AP 2. Thereafter, the STA 31 registers the information indicating that it comes to belong to AP 2 and the information indicating the channel being used by the AP 2 and the identifier thereof to the base station information management server 41.

On the other hand, since the STA 32 moves out of the cell 11 and does not belong to any access point, it refers to the information stored in the base station information management server 41 and grasps that the STA 31 that came to belong to the AP 1 before the own apparatus now comes to belong to the AP 2. Therefore, the STA 32 transmits a belonging request by means of the channel being used by the AP 2 and the identifier thereof before it performs a Scanning operation and, if it does not receive any response to the request, it repeats the Scanning operation sequentially for the channels, starting from the channel that the AP 2 is using.

5→6: The STA 32 moves into the cell 12. Since the STA 32 transmits a belonging request by means of the channel being used by the AP 2 and the identifier thereof before it performs a Scanning operation, it comes to belong to the AP 2 without performing a Scanning operation after moving into the cell 12. Thereafter, the STA 32 registers the information indicating that it comes to belong to AP 2 and the information indicating the channel being used by the AP 2 and the identifier thereof to the base station information management server 41.

6→7: The STA 31 moves out of the cell 12. As the STA 31 leaves the cell 12, it accesses the information stored in the base station information management server 41 and refers to the communication history of the own apparatus and that of the other STA. The STA 31 compares the history of the own apparatus and that of the STA 32 and performs an ordinary Scanning operation because the STA 32 comes to belong to the AP 1 and the AP 2 after the STA 31.

7→8: The STA 31 moves into cell 13. At this time, the STA 31 detects the beacon that the AP 3 transmits periodically by means of a Scanning operation and acquires information necessary for transmitting a belonging request to the AP 3 (the channel being used by the AP 3 and the identifier thereof). Then, the STA 31 transmits a belonging request according to the information it acquires and comes to belong to the AP 3. Thereafter, the STA 31 registers the information indicating that it comes to belong to AP 3 and the information indicating the channel being used by the AP 3 and the identifier thereof to the base station information management server 41.

On the other hand, since the STA 32 moves out of the cell 12 and does not belong to any access point, it refers to the information stored in the base station information management server 41 and grasps that the STA 31 that came to belong to the AP 1 and the AP 2 before the own apparatus now comes to belong to the AP 3. Therefore, the STA 32 transmits a belonging request by means of the channel being used by the AP 3 and the identifier thereof before it performs a Scanning operation and, if it does not receive any response to the request, it repeats the Scanning operation sequentially for the channels, starting from the channel that the AP 3 is using.

8→9: The STA 32 moves into the cell 13. Since the STA 32 transmits a belonging request by means of the channel being used by the AP 3 and the identifier thereof before it performs a Scanning operation, it comes to belong to the AP 3 without performing a Scanning operation after moving into the cell 13. Thereafter, the STA 32 registers the information indicating that it comes to belong to AP 3 and the information indicating the channel being used by the AP 3 and the identifier thereof to the base station information management server 41.

9→10: The STA 31 moves out of the cell 13. As the STA 31 leaves the cell 13, it accesses the information stored in the base station information management server 41 and refers to the communication history of the own apparatus and that of the other STA. The STA 31 compares the history of the own apparatus and that of the STA 32 and performs an ordinary Scanning operation because the STA 32 comes to belong to the AP 1, the AP 2 and the AP 3 after the STA 31.

With the above-described operation, each of the STAs can recognize if it is arranged at the front end or the rear end of the mobile body 100 according to the belonging history of each of the STAs although it is not defined in advance if each of the STAs is arranged at the front end or the rear end of the mobile body as viewed in the moving direction of the latter.

While the STA arranged at the rear side of the mobile body refers to the belonging history of the STA that came to belong to the access point before itself to which it has been belonging and predicts the access point to which it comes to belong next in the above-described operation example, it is not necessarily limited thereto. For example, it may alternatively be so arranged that the STA compares its own communication state and that of the other history for a predetermined number of different access points to which it and the other STA belonged (e.g., five different access points) and predicts to be belonging to the cell same as the other STA if they belonged to the same access points, the number of which is not smaller than a predetermined number (e.g., four).

### OPERATION EXAMPLE 3-2

Now, the second operation example of the communication system of this embodiment will be described below by referring to FIG. 8.

1: Since neither the STA 31 nor the STA 32 is found in the cell of any access point, each of the STA 31 and the STA 32 performs a Scanning operation, searching for an access point to which each of them is to belong to. Each of the STA 31 and the STA 32 registers the outcome of the Scanning operation for each channel in the base station information management server 41. More specifically, if each of the STAs cannot detect a beacon by way of the channel for which it firstly performs a Scanning operation, it registers the fact to the base station information management server 41 and subsequently performs a Scanning operation for the second channel. Since neither the STA 31 nor the STA 32 is found in the cell of any access point in this instance, they register the fact that they cannot detect any beacon to the base station information management server 41. The information that neither the STA 31 not the STA 32 belongs to any cell is registered as communication history of the STAs according to the outcome of the Scanning operation for all the channels.

1→2→3: The STA 31 moves into cell 11 first. The STA 31 accesses the information stored in the base station information management server 41 and refers to the communication history of the own apparatus and that of the other STA. Since neither the STA 31 nor the STA 32 belongs to any cell in this instance, the STA 31 performs an ordinary Scanning operation. If the STA 31 has performed a Scanning operation for the first through fifth channels by the time when the mobile body 100 enters to position “3”, the information indicating that the Scanning operation has been performed for the first through fifth channels and no beacon has been detected is registered to the base station information management server 41.

On the other hand, the STA 32 accesses the information stored in the base station information management server 41 before it performs a Scanning operation. Since neither the STA 31 nor the STA 32 belongs to any access point by the time when the mobile body 100 is at position “3”, the STA 32 refers to the information relating to the outcome of the Scanning operation of the STA 31. Since the information indicating that the STA 31 has performed a Scanning operation for the first through fifth channels but no beacon has been found so far is registered in this instance, the STA 32 grasps that it cannot detect any beacon if it performs a Scanning operation for the first through fifth channels. Therefore, the STA 32 performs a Scanning operation only for the sixth through 14th channels without performing any Scanning operation for the first through fifth channels.

The STA 31 and the STA 32 that have detected a beacon by means of a Scanning operation acquire information necessary for transmitting a belonging request to the AP 1 (the channel being used by the AP 1 and the identifier thereof. Then, the STA 31 and the STA 32 transmit a belonging request according to the information they acquire and come to belong to the AP 1.

3→4: As the STA 31 leaves the cell 11, it accesses the information stored in the base station information management server 41 and refers to the communication history of the own apparatus and that of the other STA. The STA 31 compares the history of the own apparatus and that of the STA 32 and performs an ordinary Scanning operation because the STA 32 comes to belong to the AP 1 after the STA 31. Then, the STA 31 registers the outcome of the Scanning operation for each channel in the base station information management server 41. Since the STA 31 is not found in the cell of any access point when the mobile body 100 is at position “4”, the information indicating that it cannot detect any beacon for all the channels is registered to the base station information management server 41. Then, the base station information management server 41 registers the information indicating that the STA 31 does not belong to any cell as belonging history according to the outcome of the Scanning operation for all the channels.

4→5→6: The STA 31 moves into cell 12 first. If the STA 31 has performed a Scanning operation for the first through eighth channels by the time when the mobile body 100 enters to position “6”, the information indicating that the Scanning operation has been performed for the first through eighth channels and no beacon has been detected is already registered to the base station information management server 41. Therefore, the STA 32 grasps that it cannot detect any beacon if it performs a Scanning operation for the first through eighth channels when it accesses the information stored in the base station information management server 41 before it actually performs a Scanning operation. Thus, the STA 32 performs a Scanning operation only for the ninth through 14th channels without performing any Scanning operation for the first through eighth channels.

The STA 31 and the STA 32 that have detected a beacon by means of a Scanning operation acquire information necessary for transmitting a belonging request to the AP 2 (the channel being used by the AP 2 and the identifier thereof. Then, the STA 31 and the STA 32 transmit a belonging request according to the information they acquire and come to belong to the AP 2.

6→7: As the STA 31 leaves the cell 11, it performs a Scanning operation in order to detect a beacon. Then, the STA 31 registers the outcome of the Scanning operation for each channel in the base station information management server 41. Since the STA 31 is not found in the cell of any access point when the mobile body 100 is at position “7”, the information indicating that it cannot detect any beacon for all the channels is registered to the base station information management server 41. Then, the base station information management server 41 registers the information indicating that the STA 31 does not belong to any cell as communication history according to the outcome of the Scanning operation for all the channels.

7→8→9: The STA 31 moves into cell 13 first. If the STA 31 has completed a Scanning operation for all the channels by the time when the mobile body 100 enters to position “9” and finished detecting a beacon, the information indicating that the STA 31 has belonged to AP 3 and the information necessary for belonging to the AP 3 (the channel being used by the AP 3 and the identifier thereof) are registered to the base station information management server 41. Thus, the STA 32 transmits a belonging request to the AP 3 and comes to belong to the AP 3 without performing any Scanning operation.

9→10: As the STA 31 leaves the cell 13, it performs a Scanning operation in order to detect a beacon. Then, the STA 31 registers the outcome of the Scanning operation for each channel in the base station information management server 41. Since the STA 31 is not found in the cell of any access point when the mobile body 100 is at position “10”, the information indicating that it cannot detect any beacon for all the channels is registered to the base station information management server 41. As the STA 32 is notified by the STA 31 of that the latter cannot detect any beacon for all the channels, it registers the fact that the STA 31 does not belong to any cell as belonging history of the STA 31.

With the above-described flow of operation, since the STA that is arranged at the front side of the mobile body as viewed in the moving direction of the latter notifies at least part of the outcome of the Scanning operation it performs, the STA that is arranged at the rear side of the mobile body does not have to perform any or all of the Scanning operation. Thus, the time period that is required to be spent from the time when an STA moves into the cell of an access point to the time when it comes to belong to the access point is reduced. As a result, the efficiency of communication is improved.

This embodiment of communication system can suitably be used for a mobile body that can move forwardly and backwardly such as railway trains because it is not necessary to define the moving direction of each STA in advance.

### Fourth Embodiment

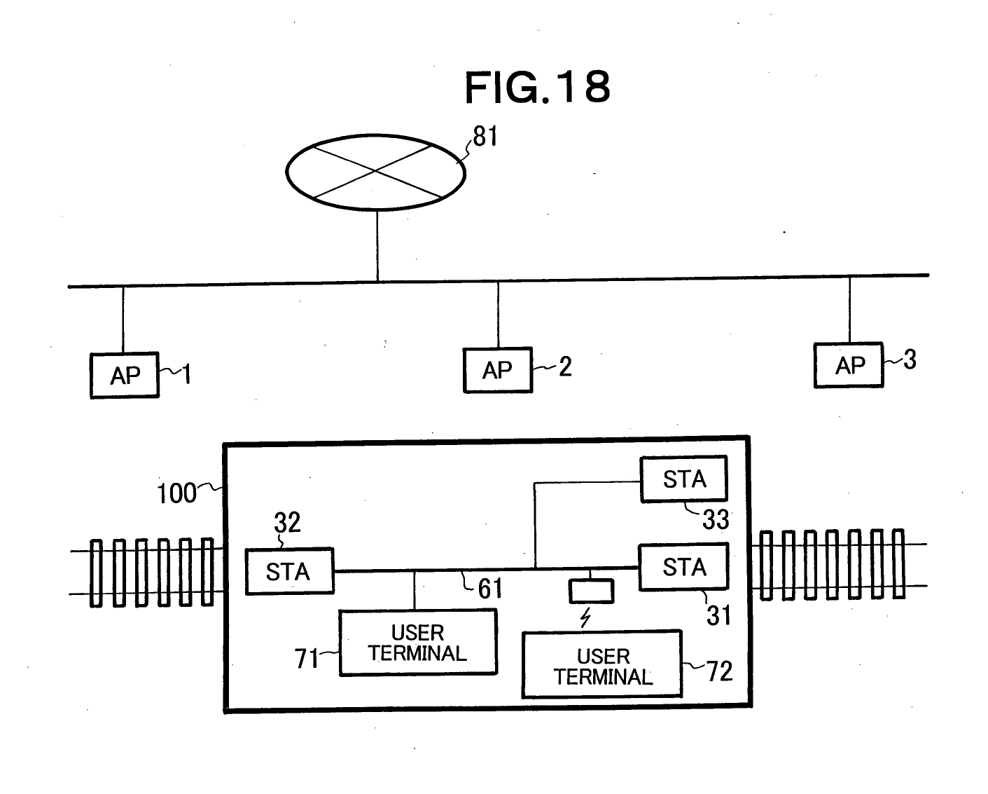

Now, the fourth embodiment of the present invention that suitably embodies the present invention will be described below. FIG. 18 shows the configuration of the fourth embodiment of communication system. This embodiment of communication system is substantially identical with the first embodiment except that it further comprises an STA 33 arranged at the front end as viewed in the moving direction of the mobile body.

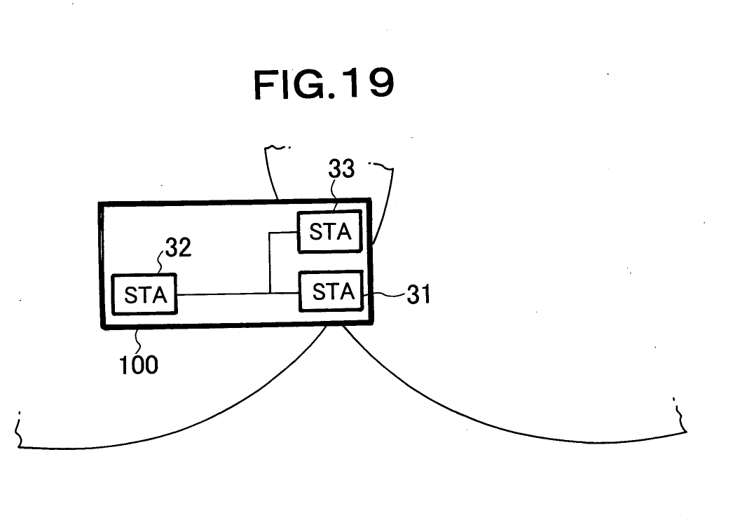

Now, an operation example of the communication system of this embodiment will be described below by referring to FIG. 19, which is a schematic illustration of a handing over operation of the communication system of this embodiment.

As the mobile body moves away from the access point to which the STA 31 belongs, the SIR (signal to interference ratio) falls. As the SIR of the access point to which it is currently belonging falls below a predetermined level, the STA 33 discards the access point and starts a Scanning operation, searching for the beacon of some other access point.

As the STA 33 moves into the cell of the next access point, it acquires information necessary for transmitting a belonging request to the access point (the channel being used by the access point and the identifier thereof) in the Scanning operation immediately after entering the cell. Then, it notifies the STA 31 of the information.

Then, as the STA 31 moves out of the cell to which it is currently belonging, it transmits a belonging request to the access point to which it comes to belong next according to the information notified by the STA 33. As a result, the STA 31 comes to belong to the AP 2 without performing any Scanning operation.

In this way, with the communication system of this embodiment, not only the STA arranged at the rear end of the mobile body as viewed in the moving direction of the latter but also the STA arranged at the front end can also reduce the time necessary for making itself belong to an access point to consequently improve the efficiency of communication.

### Fifth Embodiment

Now, the fifth embodiment of the present invention that suitably embodies the present invention will be described below.

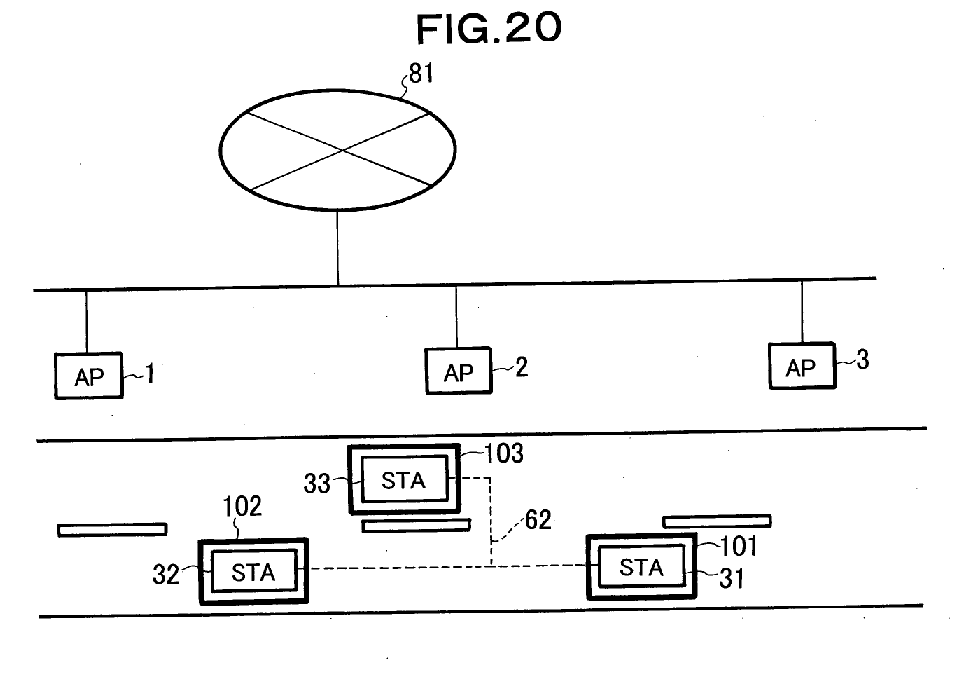

FIG. 20 shows the configuration of the fifth embodiment of communication system. In the communication system of this embodiment, access points (AP) 1, 2, 3, . . . are arranged along a road and stations (STA) 31, 32 and 33 are arranged in a distributed manner respectively on a plurality of mobile bodies (automobiles) 101, 102 and 103 moving on the road and connected to each other by way of an inter-mobile-body network 62. With the inter-mobile-body network 62, the STAs are wirelessly connected to each other.

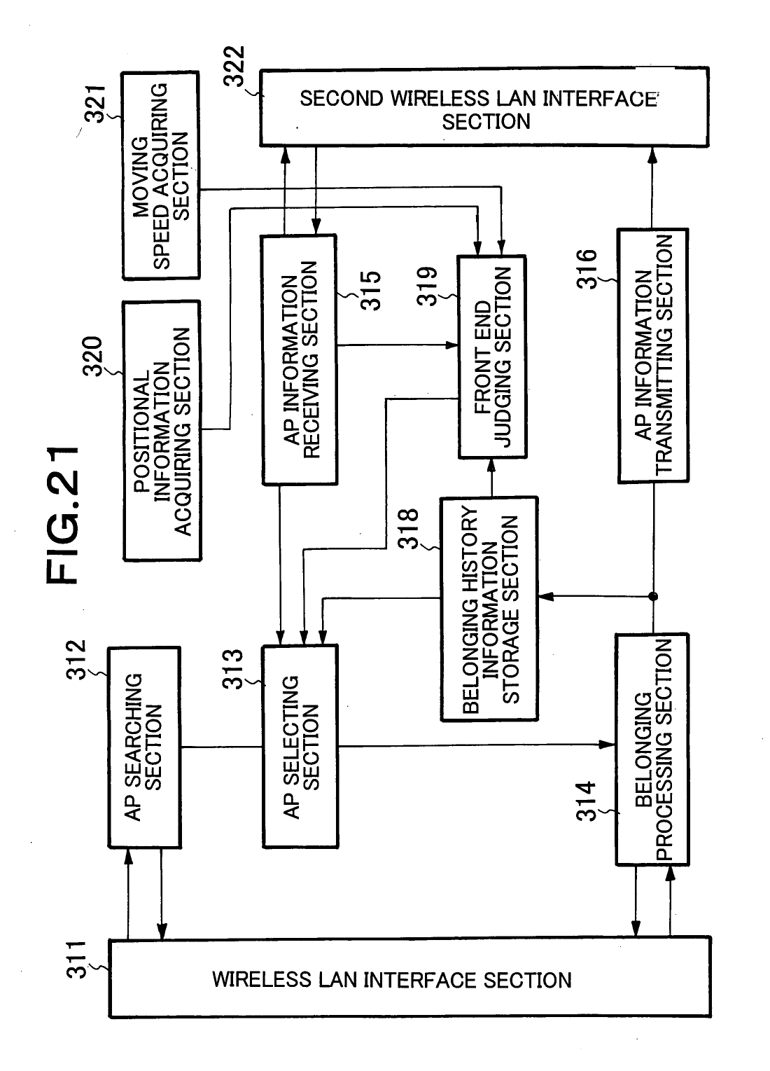

FIG. 21 shows the configuration of an STA 31 of this embodiment. The STA 31 of this embodiment is same as that of the second embodiment except that it further comprises a positional information acquiring section 320 and a moving speed acquiring section 321 and the wired LAN interface section 317 of the STA 31 of the second embodiment is replaced by a second wireless LAN interface section 322. The positional information acquiring section 320 has a function of acquiring positional information on the own apparatus (e.g., a function of observing the position of the own apparatus by means a GPS signal). The moving speed acquiring section 321 has a function of acquiring the moving speed of the mobile body 101 on which the own apparatus is mounted. The moving speed of the mobile body may be acquired as the moving speed acquiring section 321 receives a vehicle speed signal from the control apparatus (not shown) of the mobile body as input or by storing history of positional information of the own apparatus and computationally determining the moving speed by comparing it with the most updated positional information. The second wireless LAN interface section 322 is an interface for transmitting/receiving information by way of the inter-mobile-body network 62. Note that the STA 32 and the STA 33 have a configuration same as that of the STA 31.

Now, the operation of the communication system of this embodiment will be described below. Each of the STAs 31, 32 and 33 generates positional information on the own apparatus according to the GPS signal it receives. Additionally, it computationally determines its moving speed according to the positional information of the past stored in the positional information history storage section. Subsequently, it exchanges the positional information and the moving speed information it has with those of the other STAs by way of the inter-mobile-body network 62. Then, it judges if the own apparatus is arranged at the front end of the mobile body or not according to the positional information and the moving speed information on the own apparatus and the other STAs. As it executes such a judging process before it performs a Scanning operation, it can recognize if it is located at the front end of the mobile body or not so that it can operate like its counterpart of the first embodiment.

Thus, with this embodiment, if the stations are mounted respectively on a plurality of mobile bodies in a distributed manner, the station located at the rear end of each mobile body can reduce the time period it has to spend from the time when it moves into the cell of an access point to the time when it comes to be able to communicate with the access point to consequently improve the efficiency of communication.

While the present invention is described above by way of preferred embodiments, the present invention is by no means limited thereto.

For example, while the preferred embodiments are described above in terms of a railway train or an automobile, the present invention is by no means limited thereto and can be applied to any mobile body so long as the mobile body is moving along a predetermined route. For instance, access points may be arranged along a water way and stations may be arranged on one or more than one boats adapted to pass through the water way.

When a communication system according to the present invention comprises a base station information management server as in the case of the above-described third embodiment, an intra-mobile-body network (or an inter-mobile-body) may be formed by wirelessly connecting stations for communication.

Thus, the above-described embodiments may be modified and altered in various different ways.

The present invention can find applications in arrangements where stations are arranged on one or more than one mobile bodies and made to belong to any of the access points arranged along a predetermined route and connected to a network.

1-16. (canceled)

17. A communication system comprising:
a plurality of access point apparatus arranged along a predetermined route,
a plurality of station apparatus arranged on a mobile body adapted to move along the predetermined route and
an intra-mobile-body communication network for connecting the plurality of station apparatus,
the station apparatus being adapted to become belonging to one of the access point apparatus by wireless communication so as to be connected to a network by way of the access point apparatus,
the station apparatus located front-most in the moving direction of the mobile body being adapted to transmit the information acquired at the time of retrieving an access point apparatus to which the station apparatus located front-most in the moving direction of the mobile body is adapted to belong, to the station apparatus other than the station apparatus located front-most in the moving direction of the mobile body by way of the intra-mobile-body communication network.

18. The communication system according to claim 17, wherein the transmission is push transmission.

19. The communication system according to claim 17, wherein the transmission is pull transmission.

20. The communication system according to claim 17, wherein each of the station apparatus has means for judging if the own apparatus is located front-most in the moving direction of the mobile body or not.

21. The communication system according to claim 17, wherein,
when two or more than two station apparatus are located front-most in moving direction,
at least one of the station apparatus keeps on belonging to the access point apparatus while the other station apparatus retrieves an access point apparatus to which it is adapted to belong when the communication quality is degraded relative to the access point apparatus to which they are belonging.

22. A communication system comprising:
a plurality of access point apparatus arranged along a predetermined route,
a plurality of station apparatus arranged on a mobile body adapted to move along the predetermined route and
an intra-mobile-body communication network for connecting the plurality of station apparatus,
the station apparatus being adapted to become belonging to one of the access point apparatus so as to be connected to a network by way of the access point apparatus,
each of the station apparatus having storage means for storing information showing the access point apparatus to which it used to belong to,
the station apparatus located front-most in the moving direction of the mobile body being adapted to store the information it acquires at the time of retrieving an access point apparatus to be belonging to in the storage means by way of the intra-mobile-body communication network,
the station apparatus other than the station apparatus located front-most in the moving direction of the mobile body being adapted to refer to the information stored by the front-most station apparatus in the storage means prior to retrieving an access point apparatus to be belonging to.

23. The communication system according to claim 22, wherein the storage means is connected to the intra-mobile-body communication network.

24. The communication system according to claim 22, wherein the storage means is provided at the each station.

25. The communication system according to claim 22, wherein each of the station apparatus has means for judging if the own apparatus is located front-most in the moving direction of the mobile body or not.

26. The communication system according to claim 25, wherein each of the station apparatus judges if the own apparatus is located front-most in the moving direction of the mobile body or not according to the information that the own apparatus and other station apparatus stored in the storage means.

27. The communication system according to claim 22, wherein,
when two or more than two station apparatus are located front-most in the moving direction,
at least one of the station apparatus keeps on belonging to the access point apparatus while the other station apparatus retrieves an access point apparatus to which it is adapted to belong when the communication quality is degraded relative to the access point apparatus to which they are belonging.

28. A communication system comprising:
a plurality of access point apparatus arranged along a predetermined route,
a plurality of station apparatus arranged on a plurality of mobile bodies adapted to move in the same direction along the predetermined route, each of the mobile bodies having at least a station apparatus arranged thereon and
an inter-mobile-body communication network for connecting the plurality of station apparatus,
the station apparatus being adapted to become belonging to one of the access point apparatus by wireless communication so as to be connected to a network by way of the access point apparatus,
each of the station apparatus having means for judging if the mobile body where the own apparatus is arranged is located front-most in the moving direction of the mobile body or not,
the station apparatus arranged on the mobile body located front-most in the moving direction being adapted to notify the station apparatus arranged in the mobile bodies not located front-most with the information acquired at the time of retrieving an access point apparatus to be belonging to by way of the intra-mobile-body communication network.

29. The communication system according to claim 28, wherein the transmission is push transmission.

30. The communication system according to claim 28, wherein the transmission is pull transmission.

31. The communication system according to claim 28, wherein,
when two or more than two mobile bodies where station apparatus are arranged are located front-most in the moving direction, at least one of the station apparatus keeps on belonging to the access point apparatus while the other station apparatus retrieves an access point apparatus to which it is adapted to belong when the communication quality is degraded relative to the access point apparatus to which they are belonging.

32. A communication system comprising:
a plurality of access point apparatus arranged along a predetermined route,
a plurality of station apparatus arranged on a plurality of mobile bodies adapted to move in the same direction along the predetermined route, each of the mobile bodies having at least a station apparatus arranged thereon and
an inter-mobile-body communication network for connecting the plurality of station apparatus,
the station apparatus being adapted to become belonging to one of the access point apparatus by wireless communication so as to be connected to a network by way of the access point apparatus,
each of the station apparatus having storage means for storing information showing the access point apparatus to which it used to belong to,
each of the station apparatus having means for judging if it is located front-most in the moving direction of the mobile body or not,
the station apparatus arranged in the mobile body located front-most in the moving direction being adapted to store the information it acquires at the time of retrieving an access point apparatus to be belonging to in the storage means by way of the intra-mobile-body communication network,
the station apparatus arranged in the mobile bodies other than the mobile body located front-most in the moving direction being adapted to refer to the information stored by the station apparatus arranged in the mobile body located front-most in the storage means prior to retrieving an access point apparatus to be belonging to.

33. The communication system according to claim 32, wherein the storage means is connected to the intra-mobile-body communication network.

34. The communication system according to claim 32, wherein the storage means is provided at the each station.

35. The communication system according to claim 32, wherein each of the station apparatus judges if the mobile body where the own apparatus is arranged is located front-most in the moving direction or not according to the information that the own apparatus and other station apparatus stored in the storage means.

36. The communication system according to claim 32, wherein,
when two or more than two mobile bodies where station apparatus are arranged are located front-most in the moving direction, at least one of the station apparatus keeps on belonging to the access point apparatus while the other station apparatus retrieves an access point apparatus to which it is adapted to belong when the communication quality is degraded relative to the access point apparatus to which they are belonging.
